(19) United States
(12) Patent Application Publication
(10) Pub. No.: US 2026/0310010 A1
(43) Pub. Date: Oct. 8, 2026

(54) CONFIGURING OPTICAL CIRCUITS FOR FILTERING OPTICAL WAVES

(71) Applicant: Analog Photonics LLC, Boston, MA (US)

(72) Inventors: Alexander Rainville, Newton, MA (US); Michael Robert Watts, Hingham, MA (US)

(73) Assignee: Analog Photonics LLC, Boston, MA (US)

(21) Appl. No.: 19/640,989

(22) Filed: Apr. 7, 2026

Related U.S. Application Data
(60) Provisional application No. 63/785,337, filed on Apr. 8, 2025.
(60) Provisional application No. 63/829,180, filed on Jun. 24, 2025.

(51) Int. Cl. G02F 1/01; G02B 27/10; G02B 27/14

(52) U.S. Cl. CPC G02F 1/011; G02B 27/106; G02B 27/14; G02F 2203/055; G02F 2203/50

(57) ABSTRACT

An apparatus comprises: an optical filter configured to receive a first optical wave and produce, based on different amounts of phase delay provided by each of three or more two-dimensionally (2D) confined paths, a second optical wave, the optical filter comprising a plurality of optical power splitters (OPSs), each providing a portion of the first optical wave to a 2D-confined path, and a plurality of phase shifters, each configured to apply a phase shift; a gain medium configured to provide an optical gain to an optical wave; and an output coupler that couples out a fraction of the optical wave; wherein a first optical path length along a portion of a 2D-confined path between a first OPS and a phase shifter is at least two times a second optical path length along a portion of a 2D-confined path between the first OPS and a different phase shifter.

### CROSS-REFERENCE TO RELATED APPLICATION(S)

This application claims priority to and the benefit of U.S. Provisional Application Ser. No. 63/785,337, entitled “CONFIGURING OPTICAL CIRCUITS FOR FILTERING OPTICAL WAVES,” filed Apr. 8, 2025, and U.S. Provisional Application Ser. No. 63/829,180, entitled “CONFIGURING OPTICAL CIRCUITS FOR FILTERING OPTICAL WAVES,” filed Jun. 24, 2025, each of which is incorporated herein by reference.

### TECHNICAL FIELD

This disclosure relates to configuring optical circuits for filtering optical waves.

### BACKGROUND

Chip-scale devices comprising integrated circuits (ICs) have applications ranging from electronics to optical connectivity. Increasing demand for integrated circuit devices has driven advancements in their operating capabilities, physical size, and reliability alongside optimizations in manufacturing processes including production and device testing. Some IC devices can comprise electronic components configured to manipulate or transmit electric signals while other IC devices can comprise photonic structures or components configured to guide or manipulate electromagnetic waves. Some IC devices can comprise optical waveguiding structures or optical circuits configured to guide optical waves in the optical wavelength region of the electromagnetic spectrum. Some electromagnetic waves have a spectrum that has a peak wavelength that falls in a particular range of optical wavelengths (e.g., between about 100 nm to about 1 mm, or some subrange thereof), also referred to as optical waves, light waves, or simply light.

### SUMMARY

In one aspect, in general, an apparatus comprises: an input port configured to receive a first optical wave; an optical splitting network configured to provide a respective portion of the first optical wave from the input port to each phase shifter of a plurality of phase shifters, the optical splitting network comprising a plurality of optical power splitters, where each optical power splitter of the plurality of optical power splitters is configured to provide respective portions of an input optical wave to each of two or more respective outputs according to a respective optical power splitting ratio associated with each optical power splitter; the plurality of phase shifters, wherein each phase shifter is configured to apply a phase shift to an optical wave propagating through that phase shifter in response to a phase shift control signal; and an output port in optical communication with the plurality of phase shifters such that the output port is configured to provide a second optical wave comprising a respective optical wave from each phase shifter of the plurality of phase shifters; wherein the apparatus is configured such that a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path; and wherein a first optical path length along a portion of a 2D-confined path between a first optical power splitter and a phase shifter of the plurality of phase shifters is at least two times a second optical path length along a portion of a 2D-confined path between the first optical power splitter and a different phase shifter of the plurality of phase shifters.

Aspects can include one or more of the following features.

Each 2D-confined path of the set of 2D-confined paths is configured to confine a respective optical wave in two dimensions and provide a different amount of phase delay than each other 2D-confined path in the set of 2D-confined paths.

Each 2D-confined path of the set of 2D-confined paths comprises a respective portion of the optical splitting network.

Each 2D-confined path of the set of 2D-confined paths has a different physical length such that the different physical lengths provide at least some of the different amounts of phase delay.

Each 2D-confined path of the set of 2D-confined paths comprises a chromatic dispersion modifying structure configured to provide an amount of chromatic dispersion to an optical wave propagating through the chromatic dispersion modifying structure.

Each chromatic dispersion modifying structure is formed from a respective portion of a 2D-confined path of the set of 2D-confined paths, where each respective portion has at least one of a refractive index or width that is different from that of adjacent portions of the 2D-confined path, and the respective portion has a length along a propagation axis of the 2D-confined path that is different from lengths of the respective portions of each other 2D-confined path in the set of 2D-confined paths.

The set of 2D-confined paths comprises at least ten 2D-confined paths.

The set of 2D-confined paths consists of no more than 10,000 2D-confined paths.

The apparatus further comprises an optical combining network configured to combine a respective optical wave from each phase shifter of the plurality of phase shifters into the second optical wave.

Each phase shifter of the plurality of phase shifters is in optical communication with a respective optical reflector that redirects respective optical waves to use the optical splitting network as the optical combining network.

Each optical reflector comprises a Bragg grating, an optical coating comprising one or more layers of material, or an interface between a first material and a second material.

The apparatus further comprises a second optical waveguiding structure configured to provide an optical wave from the optical combining network to the output port.

The optical combining network comprises a plurality of optical power splitters, where each optical power splitter of the plurality of optical power splitters is configured to provide respective portions of an input optical wave to each of two or more respective outputs according to a respective optical power splitting ratio associated with each optical power splitter, and where the plurality of optical power splitters is arranged in a sequence along the second optical waveguiding structure.

At least one of (1) a peak optical wavelength of the first optical wave is different from a peak optical wavelength of the second optical wave or (2) an optical bandwidth of the first optical wave is different from an optical bandwidth of the second optical wave.

The optical splitting network comprises an optical waveguiding structure and at least some optical power splitters of the plurality of optical power splitters are arranged in a sequence along the optical waveguiding structure.

Each optical power splitter of the plurality of optical power splitters is arranged in a sequence along the optical waveguiding structure.

The first optical power splitter is first in the sequence.

In another aspect, in general, an apparatus comprises: an optical filter configured to receive a first optical wave at an optical filter input and produce, based at least in part on different amounts of phase delay provided by each of three or more two-dimensionally (2D) confined paths receiving different respective portions of the first optical wave, a second optical wave at an optical filter output, the optical filter comprising a plurality of optical power splitters, where each optical power splitter of the plurality of optical power splitters provides a respective portion of the first optical wave to a 2D-confined path of the three or more 2D-confined paths, and a plurality of phase shifters, wherein each phase shifter is configured to apply a phase shift to an optical wave propagating through that phase shifter in response to a phase shift control signal; a gain medium configured to provide an optical gain to an optical wave propagating around a loop that traverses through the gain medium and into the optical filter input and out of the optical filter output; and an output coupler that couples out a fraction of the optical wave propagating around the loop; wherein a first optical path length along a portion of a 2D-confined path between a first optical power splitter and a phase shifter of the plurality of phase shifters is at least two times a second optical path length along a portion of a 2D-confined path between the first optical power splitter and a different phase shifter of the plurality of phase shifters.

Aspects can include one or more of the following features.

At least one of (1) a peak optical wavelength of the first optical wave is different from a peak optical wavelength of the second optical wave or (2) an optical bandwidth of the first optical wave is different from an optical bandwidth of the second optical wave.

Each 2D-confined path of the three or more 2D-confined paths has a different physical length such that the different physical lengths provide at least some of the different amounts of phase delay.

The second optical wave is associated with a wavelength spectrum comprising a plurality of intensity peaks.

Each spacing between adjacent intensity peaks of the plurality of intensity peaks is substantially equal.

The gain medium is configured to provide a respective optical gain to each wavelength of a plurality of wavelengths.

In another aspect, in general, an apparatus comprises: an input port configured to receive a first optical wave; an optical splitting network configured to provide a respective portion of the first optical wave from the input port to each phase shifter of a plurality of phase shifters, the optical splitting network comprising a plurality of optical power splitters, where each optical power splitter of the plurality of optical power splitters is configured to provide respective portions of an input optical wave to each of two or more respective outputs according to a respective optical power splitting ratio associated with each optical power splitter; the plurality of phase shifters, wherein each phase shifter is configured to apply a phase shift to an optical wave propagating through that phase shifter in response to a phase shift control signal; an output port in optical communication with the plurality of phase shifters such that the output port is configured to provide a second optical wave comprising a respective optical wave from each phase shifter of the plurality of phase shifters; and control circuitry configured to apply a sequence of two or more sets of phase shift control signals to the plurality of phase shifters; wherein the apparatus is configured such that a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path; and wherein a first set of phase shift control signals of the two or more sets of phase shift control signals is different from a second set of phase shift control signals of the two or more sets of phase shift control signals.

Aspects can include one or more of the following features.

The second optical wave has a first peak optical wavelength based at least in part on the first set of phase shift control signals and a second peak optical wavelength based at least in part on the second set of phase shift control signals, where the first peak optical wavelength is different from the second peak optical wavelength.

The apparatus further comprises a photodetector in optical communication with the output port.

The apparatus further comprises an optical coupler in optical communication with the input port.

An optical bandwidth of the first optical wave is greater than an optical bandwidth of the second optical wave.

The second optical wave has a first optical intensity based at least in part on the first set of phase shift control signals and a second optical intensity based at least in part on the second set of phase shift control signals, where the first optical intensity is different from the second optical intensity.

At least one of the input port or the output port is in optical communication with a gain medium configured to provide an optical gain to an optical wave propagating through the gain medium.

The gain medium is configured to provide an optical gain to an optical wave propagating around a loop that traverses through the gain medium and into the input port and out of the output port.

The set of 2D-confined paths comprises at least 64 2D-confined paths.

The input port, the optical splitting network, the plurality of phase shifters, and the output port are distributed across one or more layers of a first integrated circuit device, and the control circuitry is distributed across one or more layers of a second integrated circuit device in electrical communication with the first integrated circuit device.

Aspects can have one or more of the following advantages.

Some optical circuits can be configured such that an optical circuit can be used as an optical spectral filter. In some photonic-integrated circuits (PICs), optical filters can be used to select wavelengths for laser mode control, telecom add-drop, and other applications. These filters can be characterized by their free-spectral range (FSR) or the distance in wavelength or frequency space between transmission peaks. Some filters can also be characterized by the width of the transmitted peak, which can be quantified as full-width-at-half-maximum (FWHM). In some implementations, using the methods and techniques disclosed herein, optical filters can be configured such that the optical filter is associated with a large FSR or a small FWHM transmission peak. In some examples, a larger FSR can allow adjacent resonances to not lie in the signal band of interest. In some examples, small FWHM transmission peaks can allow the selection of a narrow band of wavelengths.

Using the methods disclosed herein, optical circuits can be configured as optical filters used for applications in which the average optical path length over different paths within the optical circuits may be relevant. In some examples, these optical circuits can be configured to have a shorter average optical path length over the different paths relative to other implementations, as described in more detail below, which may be beneficial for some applications. For example, a shorter average optical path length can reduce a physical footprint of an optical circuit, and can reduce a round-trip cavity length of an optical cavity (e.g., a laser cavity) in which an optical filter is used. Shorter round-trip cavity lengths can affect associated parameters of such systems.

Without using the methods disclosed herein, some optical filters can be tuned with thermal effects, which can be associated with slow response times, small tuning ranges, and significant drive power. In addition, setting an optical filter transmission to an arbitrary wavelength using thermal effects can comprise a non-trivial calibration of multiple heater drive circuits and compensation and calibration of fabrication tolerances or process offsets. Some optical filters can also be associated with limited applicability due to external thermal influences and large power build-up that limit power handling.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1E are schematic diagrams of example optical circuits configured as optical filters.

FIG. 2A is a plot of wavelength spectra of optical waves.

FIG. 2B depicts example phase patterns that can be applied to an optical circuit.

FIGS. 3A-3C are schematic diagrams of example optical circuits configured as optical filters.

FIGS. 4A-4C are schematic diagrams of example laser cavities comprising optical filters.

FIGS. 5A-5F are schematic diagrams of example systems.

FIGS. 6A-6C are plots of numerical simulations associated with optical filters.

FIG. 7 is a plot of numerical simulations associated with optical filters.

FIGS. 8A-8C are flowcharts of example methods.

### DETAILED DESCRIPTION

In some implementations, an optical circuit can be formed as part of a system. A system can be implemented in various configurations, including as a single apparatus or as a combination of one or more apparatuses that collectively perform the functions of a system. In some examples, the one or more apparatuses can form a device, i.e., a system-on-a-chip, or the one or more apparatuses can be separate devices.

Some optical circuits can be configured as an optical spectral filter. In some implementations, an optical spectral filter associated with an FSR and a FWHM can comprise sequentially splitting an input optical signal or optical wave into portions, differentially delaying those portions with respect to each other, and then recombining the portions into an output optical signal. In other words, an optical circuit configured as an optical spectral filter can comprise an optical splitting network, a propagation region, and an optical combining network. Some optical spectral filters can be configured such that each of these steps occurs in parallel paths. Each small portion of the split optical wave can accrue a slightly different phase delay along the parallel path. This phase delay can be associated with a propagation phase that is linear with respect to frequency and can be enhanced by other effects such as chromatic dispersion and waveguide dispersion.

Chromatic dispersion refers to an effect wherein a phase delay acquired by an optical wave in a medium varies with a frequency of the optical wave. Chromatic dispersion can include material dispersion due to the frequency dependent refractive index of a material and waveguide dispersion associated with the structure and geometry of an optical waveguiding structure.

When the optical waves comprising delayed portions are recombined, only the specific frequencies where the differential accrued phase is equal to a multiple of 2π can constructively interfere and exit the final waveguide. This recombination can occur sequentially with two-dimensional guided waves and not in parallel in a free-space or slab-guided region. By splitting, propagating, and recombining an optical wave, certain wavelengths of light, or combinations thereof, can be selected by changing the relative phase of the parallel propagation region to tune the center wavelength of the filter. In other words, an optical filter can be configured to receive an optical wave and produce, based at least in part on differential phase delay provided to portions of the optical wave, an optical wave having different optical properties. As described later in more detail, in some implementations, an optical filter can be used in laser cavities to select one or more laser wavelengths.

Some optical circuits can comprise two-dimensionally (2D)-confined paths that are configured to confine an optical wave propagating along the 2D-confined path, where the 2D confinement of the optical wave is in the two dimensions that are orthogonal to the propagation direction. In some implementations, there is no portion of the 2D-confined path over which the optical wave is unconfined in one or more of those two orthogonal dimensions. For example, a 2D-confined path can comprise optical waveguides or portions of one or more optical waveguides. An optical waveguide can also be referred to as an optical waveguiding structure. In some examples, a 2D-confined path can comprise a portion of a first optical waveguide, an optical coupler that couples optical waves from the first optical waveguide to a second optical waveguide, and a portion of the second optical waveguide.

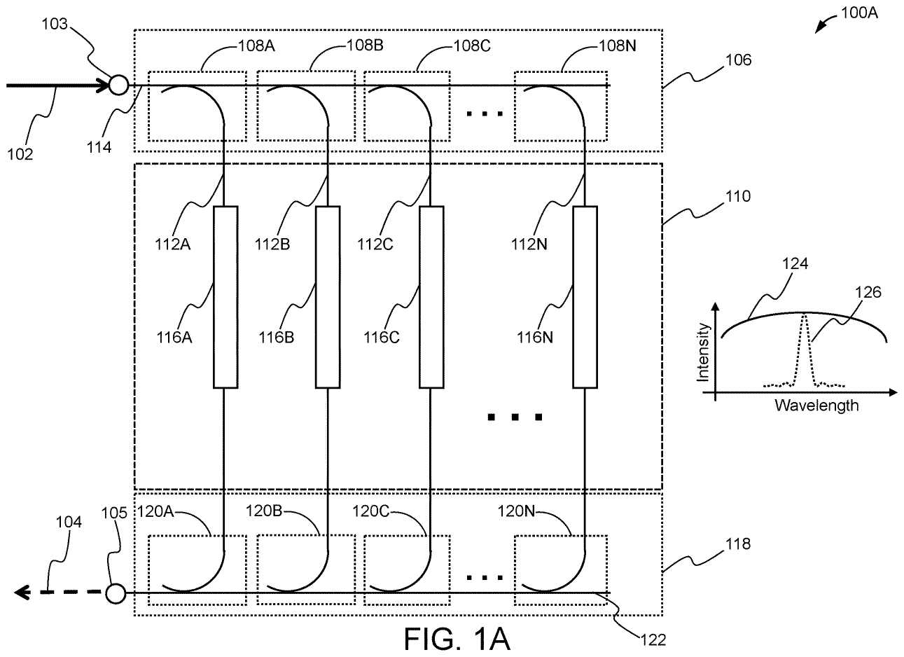

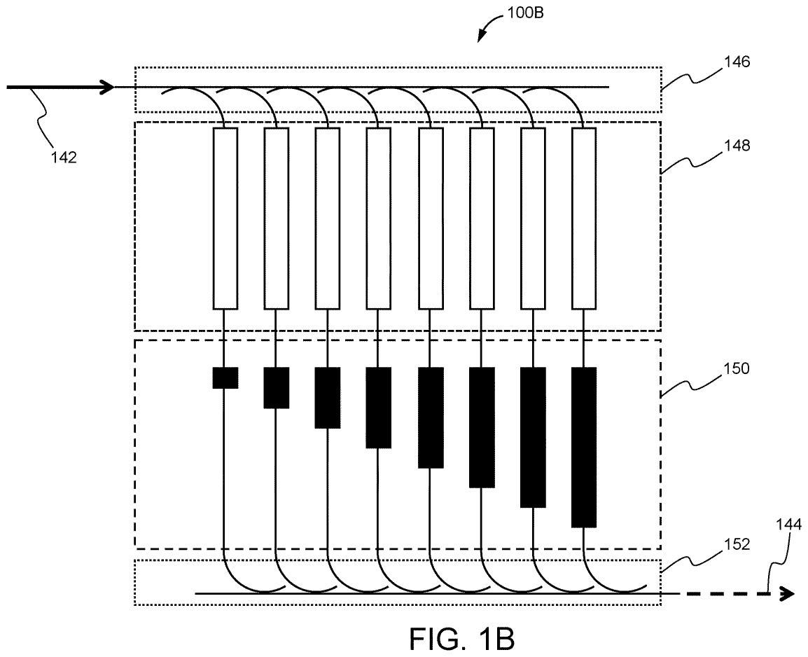

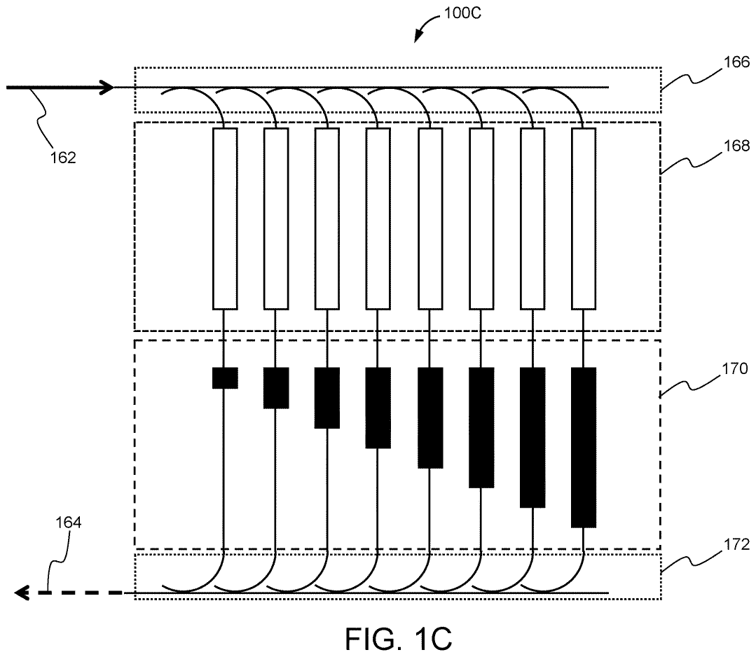

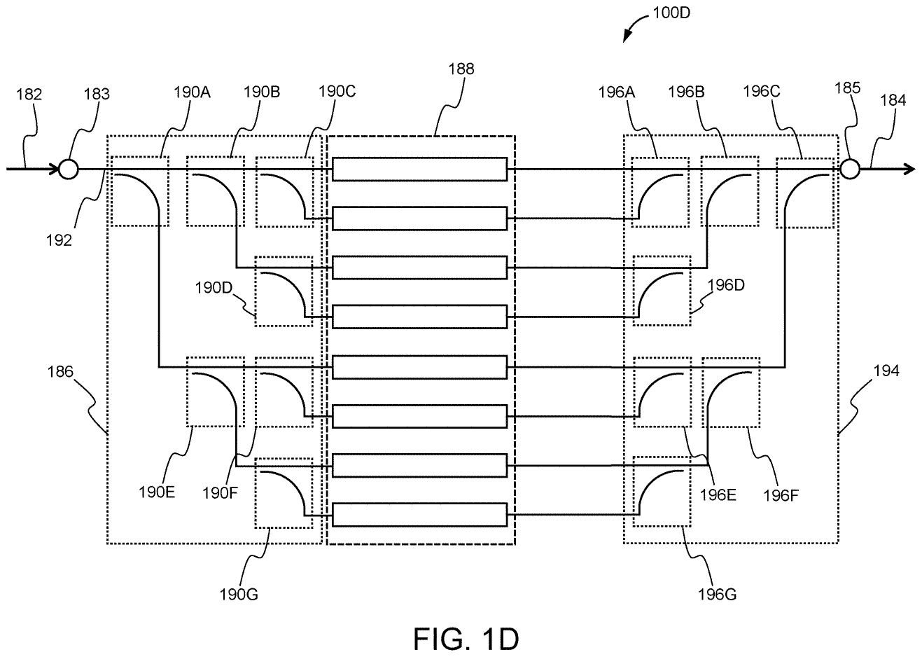

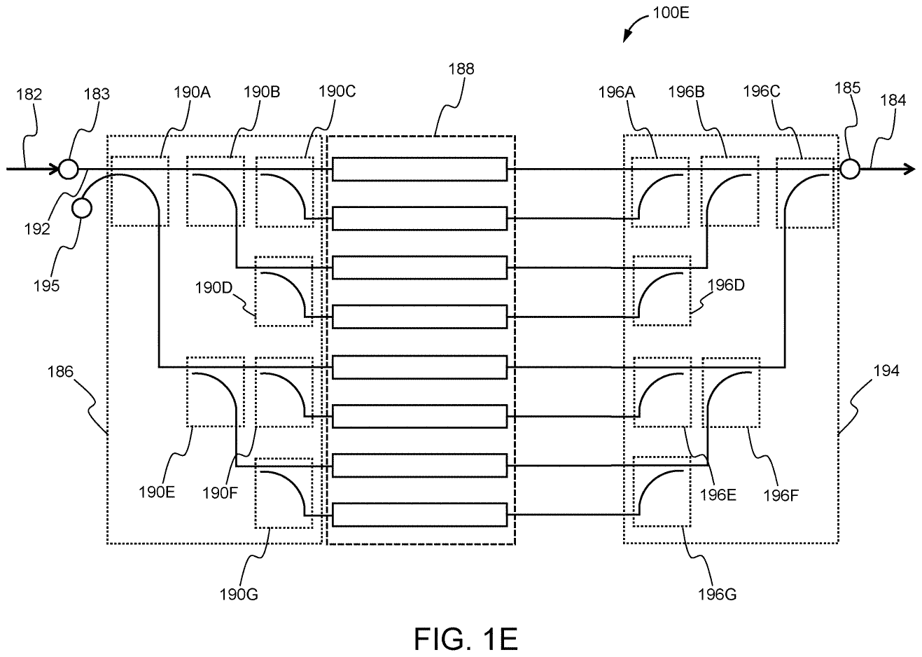

FIG. 1A is a schematic diagram of an example optical circuit 100A, i.e., an apparatus, configured as an optical filter. The optical circuit 100A is configured to receive a first optical wave 102 at an input port 103 and produce a second optical wave 104 at an output port 105. In some implementations, each of an input port and an output port can be formed from a respective portion of an optical waveguide. In this example, the first optical wave 102 and the second optical wave 104 propagate in opposite directions. The optical circuit 100A comprises an optical splitting network 106. The optical splitting network 106 comprises a plurality of optical power splitters 108A-108N, i.e., an optical power splitter 108A, an optical power splitter 108B, an optical power splitter 108C, and an optical power splitter 108N. The optical splitting network 106 is configured to distribute a respective portion of the first optical wave 102 into a set of optical waveguides 110 comprising an optical waveguide 112A, an optical waveguide 112B, an optical waveguide 112C, and an optical waveguide 112N. In this example, the optical splitting network 106 comprises sequential optical power splitters that split optical power from a main optical waveguide 114.

As shown in FIG. 1A, the optical circuit 100A comprises a plurality of phase shifters 116A-116N, i.e., a phase shifter 116A, a phase shifter 116B, a phase shifter 116C, and a phase shifter 116N. Each phase shifter of the plurality of phase shifters 116A-116N is configured to apply a phase shift to an optical wave propagating through that phase shifter of the plurality of phase shifters 116A-116N.

As shown in FIG. 1A, the output port 105 is in optical communication with the plurality of phase shifters 116A-116N via an optical combining network. The optical combining network 118 is configured to combine an optical wave from each phase shifter of the plurality of phase shifters 116A-116N into the second optical wave 104. In this example, the optical combining network 118 comprises a plurality of optical power splitters 120A-120N, i.e., an optical power splitter 120A, an optical power splitter 120B, an optical power splitter 120C, and an optical power splitter 120N. In this example, the plurality of optical power splitters 120A-120N is arranged in a sequence along a main optical waveguide 122, i.e., a bus optical waveguide. The plurality of optical power splitters 120A-120N is configured to combine optical power into the main optical waveguide 122.

The optical circuit 100A is configured such that a respective portion of the first optical wave 102 propagates from the input port 103 to the output port 105 along each two-dimensionally (2D) confined path of a set of 2D-confined paths. Each 2D-confined path of the set of 2D-confined path is configured to provide an amount of phase delay to an optical wave propagating along that 2D-confined path. By way of example, a portion of the first optical wave 102 propagates along a first (and in this example, shortest) 2D-confined path comprising a portion of the main optical waveguide 114, the optical power splitter 108A, the optical waveguide 112A, the phase shifter 116A, the optical power splitter 120A, and the main optical waveguide 122. Likewise, a portion of the first optical wave 102 propagates along each of multiple other 2D-confined paths, including a second (and in this example, longest) 2D-confined path comprising a portion of the main optical waveguide 114, the optical power splitter 108N, the optical waveguide 112N, the phase shifter 116N, the optical power splitter 120N, and the main optical waveguide 122. Optical waves propagating along these 2D-confined paths can acquire phase delay based on optical path lengths or physical lengths of the 2D-confined paths. In this example, the first 2D-confined path has a shorter optical path length from each of the other 2D-confined paths.

In other words, a 2D-confined path can have a physical length such that an optical wave acquires an amount of phase delay as the optical wave propagates through the 2D-confined path. In other words, a 2D-confined path can have a different physical length such that the physical lengths provide at least some of the different amounts of phase delay.

Such implementations can allow for optical waves propagating along these optical paths to acquire phase delay such that, when the optical waves are combined, frequencies or wavelengths of the optical wave can interfere such that the optical circuit 100A can be used as a filter. FIG. 1A also depicts an example wavelength spectrum 124 associated with the first optical wave 102 and an example wavelength spectrum 126 associated with the second optical wave 104. As shown by the wavelength spectrum 124 and the wavelength spectrum 126, the optical circuit 100A can modify the frequency content, or filter, an optical wave propagating through the optical circuit 100A.

An optical wave in the second (and longest) 2D-confined path propagates along a longer optical path of the main optical waveguide 114 relative to an optical wave in the first (and shortest) 2D-confined path. In other words, a second optical path length along a portion of a 2D-confined path between a first optical power splitter, i.e., the optical power splitter 108A, and a phase shifter of the plurality of phase shifters, i.e., the phase shifter 116A, can be different from a first optical path length along a portion of a 2D-confined path between the first optical power splitter, i.e., the optical power splitter 108A, and a different phase shifter of the plurality of phase shifters, i.e., the phase shifter 116N. In some implementations, the first optical path length can be at least two times a second optical path length (or at least 5 times, or at least 10 times). Each of these optical path lengths can be configured to apply a different amount of phase delay to optical waves.

In some examples, configuring an optical circuit to have particular optical path lengths between optical power splitters and phase shifters can allow for an average optical path length within the optical circuit to be reduced compared to other implementations. For example, an asymmetry in optical path lengths (and phase delay) between the first optical power splitter and the entrances of different respective optical phase shifters of the different paths enables the first (and shortest) path to be shorter than it would be if the optical splitting network 106 had a symmetric arrangement with equal optical path lengths between the first optical power splitter and the entrances of all of the optical phase shifters. In the cases in which each of the other paths is longer by a particular length from the next shortest path, the average over all paths will also be shorter in the asymmetric arrangement than in such a symmetric arrangement. In other words, incorporating path length differences within certain regions of an optical circuit can reduce path lengths within other regions of the optical circuit, thereby reducing an average path length within the optical circuit. Such implementations can reduce a physical footprint associated with an optical circuit, facilitating integration of an optical circuit into larger architectures. By way of example, referring to FIG. 1A, portions of the main optical waveguide 114 can be configured to provide phase delay to optical waves and such lengths of other portions of the circuit can be reduced. By way of example, a path length between an optical power splitter and a phase shifter, such as the optical power splitter 108N and the phase shifter 116N or the phase shifter 116N and the optical power splitter 120N, can be reduced compared to other implementations.

As shown in FIG. 1A, each optical power splitter of the plurality of optical power splitters 108A-108N is arranged in a sequence along the main optical waveguide 114. In this example, the optical power splitter 108A associated with the second optical path length is first in the sequence while the optical power splitter 108N associated with the first optical path length is last in the sequence.

In some examples, a phase shifter, such as a phase shifter of the plurality of phase shifters 116A-116N, can be configured to apply a phase shift to an optical wave in response to a phase shift control signal. A phase shift control signal can be provided to a phase shifter by control circuitry. In other words, a different respective phase shift control signal can be provided to each phase shifter by control circuitry. In some implementations, control circuitry can be formed on an integrated circuit device, as described later.

In some examples, a peak transmission of an optical filter can be frequency tuned through adding a phase offset into each channel through a phase modulator. This phase offset can be induced through electro-optical, thermal optical or other effects. The phase can be wrapped so each phase shifter is capable of up to 2π phase excursion.

FIG. 1B is a schematic diagram of an example optical circuit 100B, i.e., an apparatus, that can be utilized as an optical filter. The optical circuit 100B is configured to receive a first optical wave 142 at an input port and produce a second optical wave 144 at an output port. In this example, the first optical wave 142 and the second optical wave 144 propagate in the same direction. The optical circuit 100B comprises an optical splitting network 146 that is configured to distribute a respective portion of the first optical wave 142 into each 2D-confined path of a plurality of 2D-confined paths. In this example, the optical splitting network 146 comprises sequential power splitters that split optical power from a main, or “bus,” 2D-confined path, i.e., an optical waveguide.

Each 2D-confined path of the plurality of 2D-confined paths comprises a respective phase shifter such that the optical circuit 100B comprises a plurality of phase shifters 148. Each phase shifter of the plurality of phase shifters 148 is configured to apply a phase shift to an optical wave propagating through a 2D-confined path. Each 2D-confined path of the plurality of 2D-confined paths further comprises a respective chromatic dispersion modifying structure such that the optical circuit 100B comprises a plurality of chromatic dispersion modifying structures 150. Each chromatic dispersion modifying structure of the plurality of chromatic dispersion modifying structures 150 is configured to apply a phase delay based on chromatic dispersion to a portion of an optical wave propagating through a 2D-confined path. An optical combining network 152 is configured to combine an optical wave from each 2D-confined path of the plurality of 2D-confined paths into the second optical wave 144.

In some implementations, a chromatic dispersion modifying structure can be formed from a respective portion of a 2D-confined path, where the portion has at least one of a refractive index or width that is different from that of adjacent portions of the 2D-confined path, and the respective portion has a length along a propagation axis of the 2D-confined path that is different from lengths of the respective portions of each other 2D-confined path in the set of 2D-confined paths. In other words, a chromatic dispersion modifying structure can implement periodic differential phase delay through waveguide index modifications, waveguide length modifications, or some combination thereof.

FIG. 1C is a schematic diagram of an example optical circuit 100C configured as an optical filter. The optical circuit 100C is configured to receive a first optical wave 162 at an input port and produce a second optical wave 164 at an output port. In this example, the first optical wave 162 and the second optical wave 164 propagate in the opposite directions. The optical circuit 100C comprises an optical splitting network 166 that is configured to distribute a respective portion of the first optical wave 162 into each 2D-confined path of a plurality of 2D-confined paths. In this example, the optical splitting network 166 comprises sequential power splitters that split optical power from a main 2D-confined path. Each 2D-confined path of the plurality of 2D-confined paths comprises a respective phase shifter such that the optical circuit 100C comprises a plurality of phase shifters 168. Each phase shifter of the plurality of phase shifters 168 is configured to apply a phase shift to an optical wave propagating through a 2D-confined path.

Each 2D-confined path of the plurality of 2D-confined paths further comprises a respective chromatic dispersion modifying structure such that the optical circuit 100C comprises a plurality of chromatic dispersion modifying structures 170. Each chromatic dispersion modifying structure of the plurality of chromatic dispersion modifying structures 170 is configured to apply a delay to a portion of an optical wave propagating through a 2D-confined path. An optical combining network 172 is configured to combine an optical wave from each 2D-confined path of the plurality of 2D-confined paths into the second optical wave 164. In this example, the optical combining network 172 comprises sequential power splitters that combine optical power into a main 2D-confined path. In some examples, the delay associated with the plurality of chromatic dispersion modifying structures 170 can add to a differential delay associated with optical waves recombining in the main 2D-confined path of the optical combining network 172.

FIG. 1D is a schematic diagram of an example optical circuit 100D. The optical circuit 100D is configured to receive an optical wave 182 at an input port 183. The optical circuit 100D is configured to produce an optical wave 184 at an output port 185. The optical circuit 100D comprises an optical splitting network 186. The optical splitting network 186 is configured to provide a respective portion of an optical wave from the input port 183 to each phase shifter of a plurality of phase shifters 188. In this example, the optical splitting network 186 comprises a plurality of optical power splitters 190A-190G, i.e., an optical power splitter 190A, an optical power splitter 190B, an optical power splitter 190C, an optical power splitter 190D, an optical power splitter 190E, an optical power splitter 190F, and an optical power splitter 190G. At least some of the optical power splitters of the plurality of optical power splitters 190A-190G are arranged along an optical waveguide 192. In this example, the optical power splitter 190A, the optical power splitter 190B, and the optical power splitter 190C are arranged along the optical waveguide 192.

As shown in FIG. 1D, the optical circuit 100D is configured such that a respective portion of an optical wave propagates from the input port 183 to the output port 185 along a respective 2D-confined path of a set of 2D-confined paths configured to provide a particular amount of phase delay. The optical circuit 100D is configured such that an optical wave propagates along a first optical path comprising a portion of a 2D-confined path between a first optical power splitter, i.e., the optical power splitter 190A, and a phase shifter of the plurality of phase shifters, i.e., either of the phase shifters to which the optical power splitter 190G provides optical waves. The optical circuit 100D is configured such that an optical wave propagates along a second optical path comprising a portion of a 2D-confined path between the first optical power splitter, i.e., the optical power splitter 190A, and another phase shifter of the plurality of phase shifters, i.e., either of the phase shifters to which the optical power splitter 190C provides optical waves. In this example, a path length associated with the first optical path can be at least two times a path length associated with the second optical path (or at least 5 times, or at least 10 times).

The optical circuit 100D further comprises an optical combining network 194. In this example, the optical combining network 194 comprises a plurality of optical power splitters 196A-196G, i.e., an optical power splitter 196A, an optical power splitter 196B, an optical power splitter 196C, an optical power splitter 196D, an optical power splitter 196E, an optical power splitter 196F, and an optical power splitter 196G.

As previously described, a footprint of an optical circuit can be reduced by configuring portions of the optical circuit to apply phase delay in a particular manner. For the optical circuit 100D, portions of the optical splitting network, such as a portion of an optical waveguide between the optical power splitter 190A and the optical power splitter 190E, can apply phase delay in an asymmetric path length arrangement where some paths are shorter than other paths between an initial optical power splitter and different entrances of respective phase shifters. Such implementations can allow for a reduction in an optical path length later on in the optical circuit, such as before and/or after the plurality of phase shifters 188, to reduce a minimum path length of the different optical paths within the optical circuit, and thus to also reduce an average path length within the optical circuit.

In some implementations, a set of 2D-confined paths can comprise at least three 2D-confined paths. By way of example, a set of 2D-confined paths can comprise at least ten 2D-confined paths. In some implementations, scaling a set of 2D-confined paths can be associated with fabrication and usage difficulties. Such implementations can consist of a limited number of 2D-confined paths. By way of example, some implementations can comprise no more than 10,000 2D-confined paths.

As shown in FIGS. 1A-1D, optical splitting networks or optical combining networks can comprise power splitters or optical power splitters that are configured to provide a portion of an optical wave received at input port to each of two or more output ports according to an optical power splitting ratio. In other words, an optical power splitter can be configured to provide respective portions of an input optical wave to each of two or more respective outputs according to a respective optical power splitting ratio associated with that optical power splitter. Referring back to FIG. 1A, each optical power splitter includes a portion of the main optical waveguide 114 such that each optical power splitter provides a portion of an optical wave to a next portion of the main optical waveguide 114 and to a phase shifter of the plurality of phase shifters 116A-116N.

Some optical power splitters can comprise any number of input ports, any number of output ports, and any number of splitting ratios. For instance, each of power splitters can be configured as 1×2 50/50 splitters, wherein 50% of the optical power is split into each of the output ports. Some optical splitting networks can comprise other arrangements of input ports and output ports, i.e., 1×3, 1×4, 2×2, or 2×3. Some optical splitting networks can be configured such that other amounts of optical power are coupled into output ports, i.e., 25%/75%, 75%/25%, 10%/90%. Referring back to FIGS. 1A-1C, an optical splitting network can comprise a sequence of power splitters with increasing splitting ratios such that each optical waveguide contains a uniform optical power.

In some implementations, configuring optical power splitters to have increasing splitting ratios can be associated with fabrication or design challenges leading to less-than-ideal optical splitting behavior and a decrease in filter performance. In some implementations, each optical power splitter of the plurality of optical power splitters 190A-190G can be configured as a 50/50 splitter. Such implementations can mitigate challenges associated with configuring optical power splitters to have splitting ratios relative to other optical power splitters.

FIG. 1E is a schematic diagram of an example optical circuit 100E. The optical circuit 100E is configured similarly to the optical circuit 100D. In this example, the optical circuit 100E further comprises a second input port 195. In some implementations, an optical wave can be provided to the optical circuit 100E via one or both of the input port 183 or the second input port 195.

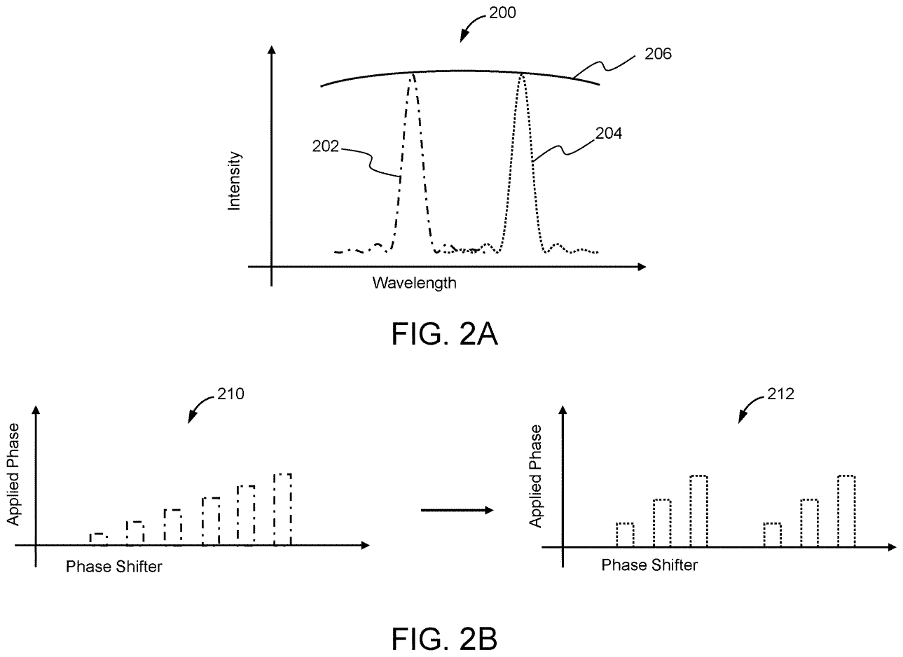

FIG. 2A is an example plot 200 associated with input and output optical waves of an optical filter. The plot 200 depicts a wavelength spectrum 206 associated with the input optical wave, wavelength spectrum 202 associated with a first output optical wave, and a wavelength spectrum 204 associated with a second output optical wave. As shown in FIG. 2A, a center or peak optical wavelength of the input optical wave is different from a center or peak optical wavelength of either of the first output optical wave or the second output optical wave. In some implementations, an optical bandwidth, as measured by a FWHM, of the input optical wave can be different from that of an output optical wave. In other words, an optical bandwidth of an input optical wave can be different from an optical bandwidth of an output optical wave.

In some examples, by inputting an optical wave having the wavelength spectrum 206 into an optical filter, the optical filter can be tuned, i.e., by applying phase shifts to phase shifters, to output an optical wave having the wavelength spectrum 202 or an optical wave having the wavelength spectrum 204. In some examples, a phase shifter of an optical filter, i.e., a phase shifter of the plurality of phase shifters 148 shown in FIG. 1B, can be configured to apply a phase shift to an optical wave in response to a phase shift control signal. FIG. 2B depicts an example first set of phase shift control signals 210 and an example second set of phase shift control signals 212 that can be applied to phase shifters. The first set of phase shift control signals 210 can be associated with a first output optical wave, for instance the wavelength spectrum 202 shown in FIG. 2A. By changing the phase shift control signals to the second set of phase shift control signals 212, the peak frequency transmission of an optical filter can also be changed, for instance to the wavelength spectrum 204 shown in FIG. 2A. In other words, by tuning phase shifts applied to optical waves, an optical filter can be configured such that transmission properties of the optical filter, i.e., a center wavelength or optical bandwidth of a transmitted optical wave, can be tuned.

In some implementations, an optical circuit configured as an optical filter can be formed on a first integrated circuit chip. As previously described, some optical filters can comprise phase shifters that are configured to apply a phase shift to an optical wave. Some implementations of phase shifters can apply a phase shift to an optical wave using electrical or thermal means. Some phase shifters can be controlled by circuitry on a second integrated circuit chip. Chip architectures can be designed to connect a first integrated circuit chip comprising photonic structures, i.e., phase shifters, and a second integrated circuit chip comprising control circuitry by conductive structures that provide electrical communication between photonic structures and control circuitry. An example of a chip architecture is a flip-chip configuration wherein a first integrated circuit chip is “flipped” and bonded onto a second integrated circuit chip with external circuitry.

In some implementations, an output optical wave can have a wavelength spectrum that comprises a plurality of intensity peaks, i.e., both of the wavelength spectrum 202 and the wavelength spectrum 204. As described later, a wavelength spectrum can comprise a plurality of intensity peaks, where each intensity peak is semi-regularly spaced from another intensity peak along the wavelength axis. In other words, an optical wave can be associated with a wavelength spectrum comprising a plurality of intensity peaks that are periodically spaced in the wavelength domain.

Some optical filters can be used in “double pass” configuration, where a reflector is inserted at some point after some differential phase is accrued such that light travels backwards through the structure a second time. In some implementations of a double pass configuration, transmission properties of an optical filter can also be tuned using phase shifters. In some examples, the phase shifters may only apply up to a π phase shift for full tuning. Alternatively, the phase shifters can apply a phase shift of multiples of π, such as 2π, 3π . . . , Nπ.

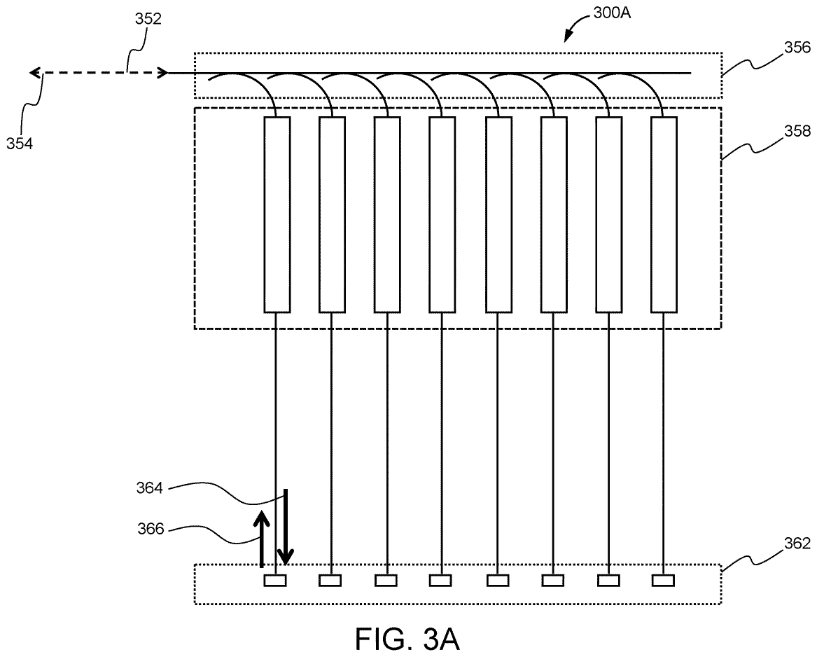

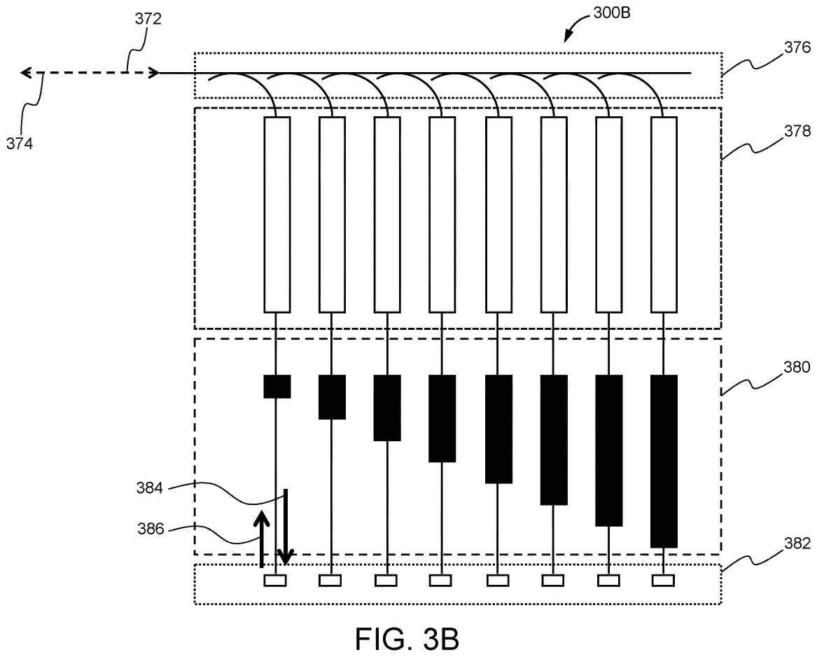

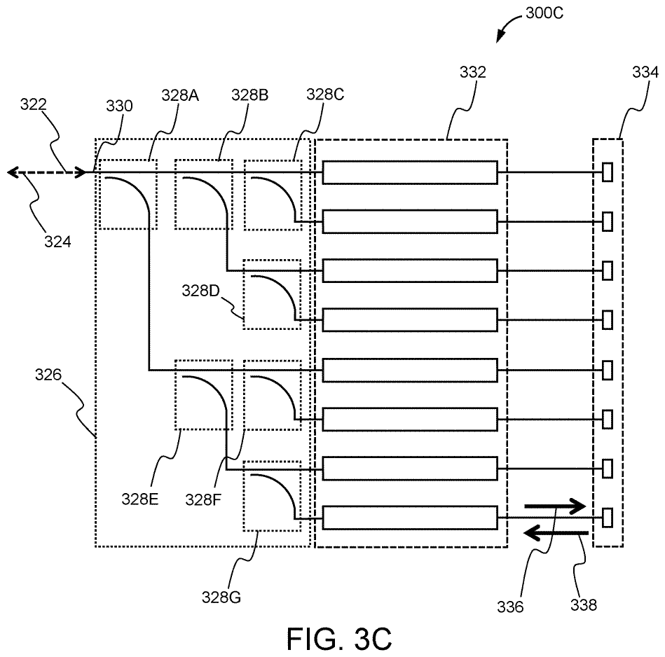

FIG. 3A is a schematic diagram of an example optical circuit 300A configured as an optical filter with a “double pass” configuration. The optical circuit 300A is configured to receive an optical wave 352 and produce an optical wave 354 from an input/output port. The optical circuit 300A comprises an optical splitting network 356 configured to distribute a respective portion of the optical wave 352 into each 2D-confined path of a set of 2D-confined paths. Each 2D-confined path comprises a respective phase shifter such that the optical circuit 300A comprises a set of phase shifters 358. In this example, segments of the 2D-confined paths are configured to apply a phase delay to an optical wave. The optical circuit 300A further comprises a set of optical reflectors 362 such that an end of each 2D-confined path is in optical communication with a respective optical reflector of the set of optical reflectors 362. Each optical reflector redirects respective optical waves such that the optical splitting network 356 can be used as an optical combining network. By way of example, an arrow 364 is included to show the direction of an optical wave before reflection by the optical reflector and an arrow 366 is included to show the direction of an optical wave after reflection by the optical reflector.

FIG. 3B is a schematic diagram of an example optical circuit 300B configured as an optical filter with a “double pass” configuration. The optical circuit 300B is configured to receive an optical wave 372 and produce an optical wave 374 from an input/output port. The optical circuit 300B comprises an optical splitting network 376 configured to distribute a respective portion of the optical wave 372 into each 2D-confined path of a set of 2D-confined paths. Each 2D-confined path comprises a respective phase shifter and a respective chromatic dispersion modifying structure such that the optical circuit 300B comprises a set of phase shifters 378 and a set of chromatic dispersion modifying structures 380. The optical circuit 300B further comprises a set of optical reflectors 382 such that an end of each 2D-confined path is in optical communication with a respective optical reflector of the set of optical reflectors 382. Each optical reflector redirects respective optical waves such that the optical splitting network 376 can be used as an optical combining network. By way of example, an arrow 384 is included to show the direction of an optical wave before reflection by the optical reflector and an arrow 386 is included to show the direction of an optical wave after reflection by the optical reflector.

In some implementations, each 2D-confined path of a set of 2D-confined paths can have a different physical length such that the different physical lengths provide at least some of the different amounts of phase delay. In some implementations, a chromatic dispersion modifying structure can comprise a portion of a 2D-confined path having a length configured to provide the chromatic dispersion.

FIG. 3C is a schematic diagram of an example optical circuit 300C. The optical circuit 300C is configured to receive an optical wave 322 and provide an optical wave 324 to an input/output port. The optical circuit 300C comprises an optical splitting network 326. The optical splitting network 326. In this example, the optical splitting network 326 comprises a plurality of optical power splitters 328A-328G, i.e., an optical power splitter 328A, an optical power splitter 328B, an optical power splitter 328C, an optical power splitter 328D, an optical power splitter 328E, an optical power splitter 328F, and an optical power splitter 328G. At least some optical power splitters of the plurality of optical power splitters 328A-328G are arranged along an optical waveguide 330. In this example, the optical power splitter 328A, the optical power splitter 328B, and the optical power splitter 328C are arranged along the optical waveguide 330. The optical circuit 300C further comprises a plurality of phase shifters 332 to which the optical splitting network 326 is configured to provide portions of optical waves.

The optical circuit 300C further comprises a set of optical reflectors 334 such that an end of each 2D-confined path is in optical communication with a respective optical reflector of the set of optical reflectors 334. Each optical reflector redirects respective optical waves such that the optical splitting network 326 can be used as an optical combining network. By way of example, an arrow 336 is included to show the direction of an optical wave before reflection by the optical reflector and an arrow 338 is included to show the direction of an optical wave after reflection by the optical reflector.

As shown in FIGS. 3A-B, an optical reflector can comprise elements or features that transform a direction of propagation of an optical wave. In other words, an optical reflector can couple a forward-propagating optical wave into a backward-propagating optical wave. Some examples of optical reflectors include end mirrors that can provide broadband or wavelength-selective reflection. An optical reflector can be implemented with on-chip materials such that the optical filter comprises a Bragg grating. Some optical reflectors can be formed by coating the edge of an optical device with a reflective material, or through other means. In other words, an optical reflector can comprise an optical coating comprising one or more layers of material. Some optical reflectors can be formed by shaping an end of an optical device, i.e., by straight cleaving the end, such that a Fresnel reflection of an optical wave occurs. In some implementations, a reflection of an optical wave can occur at an interface between a first material having a refractive index, i.e., a substrate of an optical device, and a second material having a second refractive index, i.e., air.

In some implementations, an optical filter can be used as an optical switch to route frequencies to respective output waveguides. In some cases, multiple optical frequencies can be present in at an input port. Some applications can involve selecting a portion of those frequencies into one or more output waveguides for the purposes of optical routing or for detection. Some applications can involve tuning the bandwidth of selected frequencies, such as in optical communications systems or in spectrometers. In other words, an optical circuit configured as an optical filter can be configured to provide optical waves to each optical waveguide of one or more optical waveguides, such that each optical waveguide has optical waves associated with one or more optical frequencies.

In some implementations, an optical filter can be included inside a laser cavity to select one or more longitudinal laser modes for lasing. Some laser cavities can be implemented as a linear cavity comprising a double-pass filter, or as a ring-cavity comprising a full-length filter.

In some implementations, an optical filter with tunable phase shifters, i.e., electro-optical phase shifters with a control voltage, can be set so the transmission is minimized across all wavelengths. Some optical filters can thus be used as an off/on modulator for the signal, including in a laser cavity where an optical filter could be used to change the cavity quality factor (Q-switch) and induce short pulse formation, or to quickly modulate the laser instead of using an external modulator.

Inside a laser cavity, a switch can be used to modulate the cavity output, including on/off modulation that turns the output off by increasing the cavity loss above the gain and thus suppressing output. In some optical cavities where the gain material upper-state lifetime is long (i.e. there is a significant amount of stored energy in the gain material), rapidly turning the filter on (reducing cavity loss and allowing the cavity to lase) can deplete that stored energy and form a large pulse (as in Q-switching). In cavities where the gain material has a short lifetime, modulating the cavity loss may not lead to high-energy pulse formation but can still modulate the optical output amplitude higher or lower without turning the output completely off.

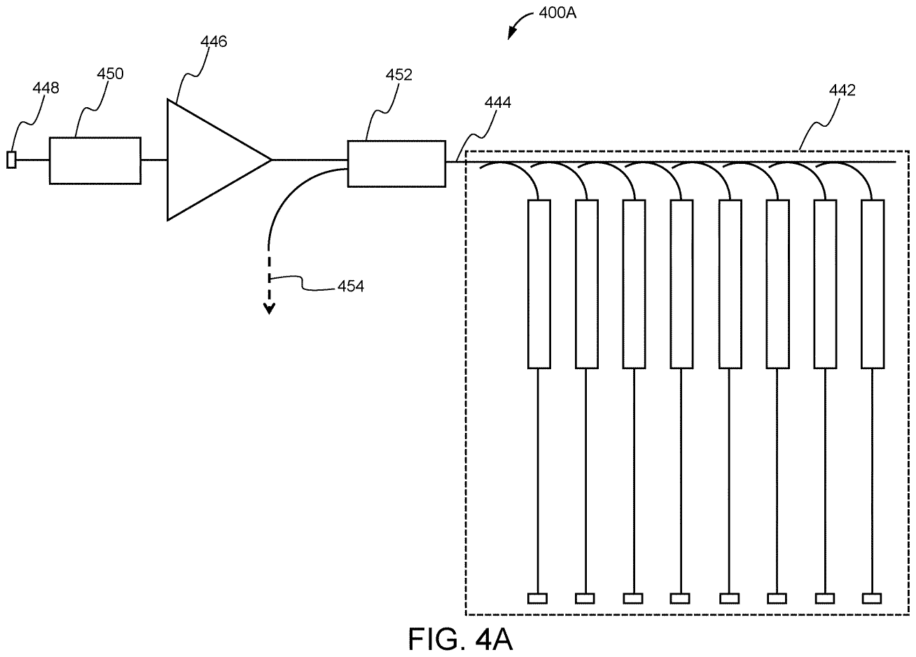

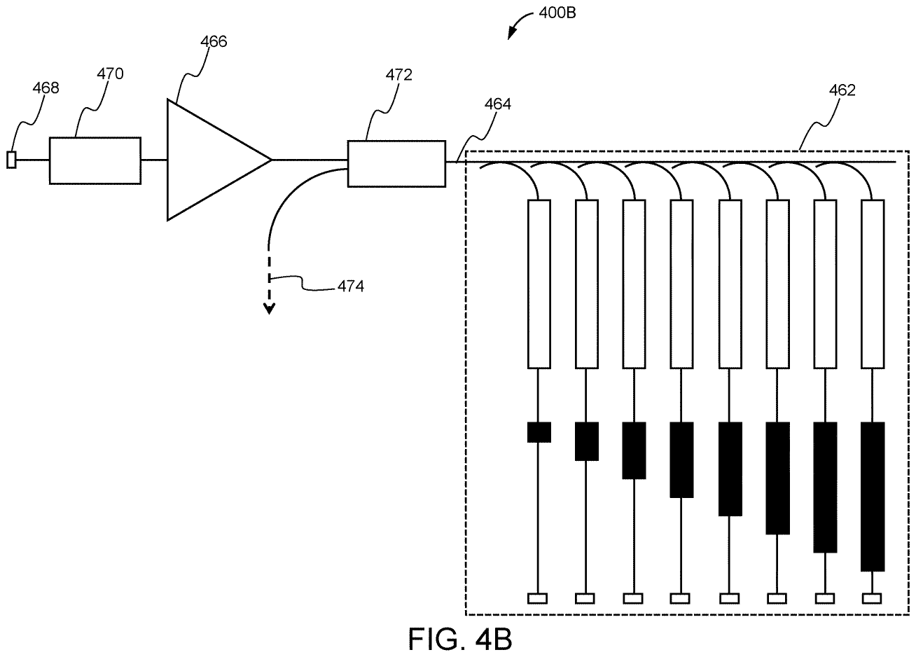

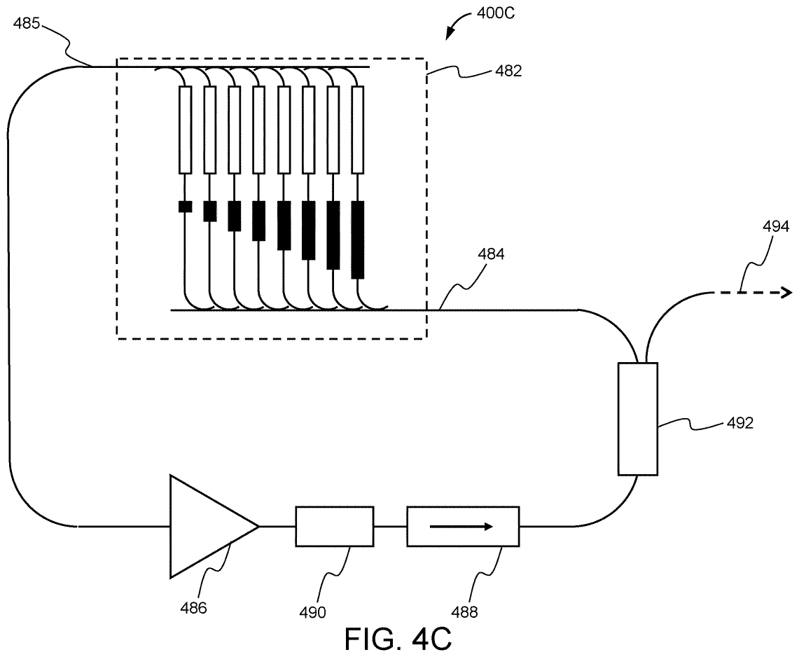

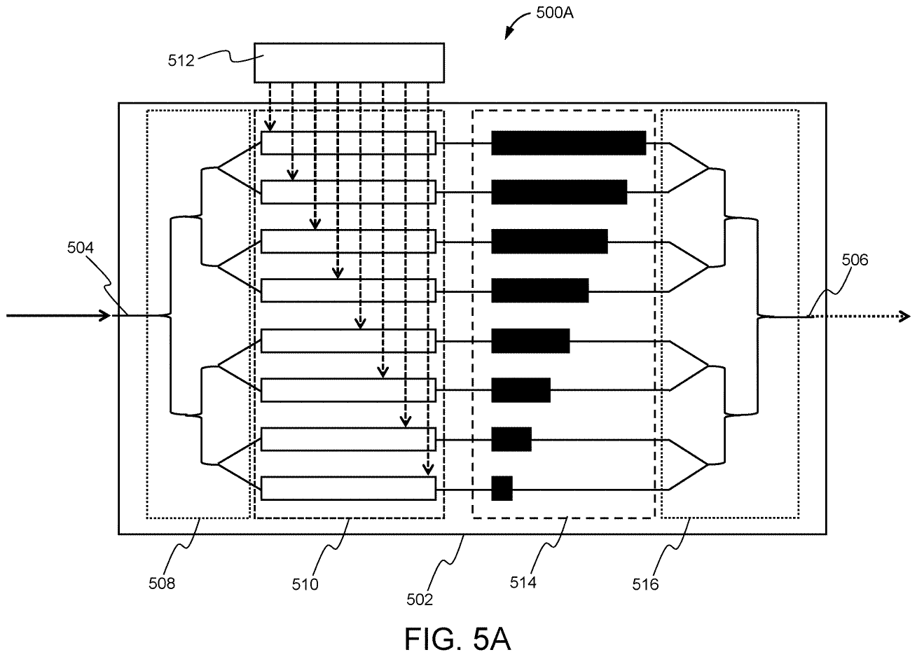

FIG. 4A is a schematic diagram of an example laser cavity 400A comprising an optical filter 442 that is configured as the optical circuit 300A shown in FIG. 3A. The laser cavity 400A is an example implementation of a standing-wave laser cavity using the optical filter 442 as a wavelength filter. In some implementations, a laser cavity can comprise more than one wavelength selective element. The optical filter 442 comprises an input/output port 444 that is configured to receive an optical wave and provide an optical wave. In some examples, the input/output port 444 can be referred to as an optical filter input and an optical filter output, as the input/output port 444 is configured to receive an optical wave and provide an optical wave. The laser cavity 400A further comprises a gain medium 446 configured to provide an optical gain to an optical wave propagating through the laser cavity 400A. The laser cavity 400A further comprises an optical reflector 448 and a cavity length control module 450, which is configured to control the length of the cavity and optical mode overlap within the cavity. An optical wave propagates in the laser cavity 400A around a loop that traverses through the gain medium 446, into the input/output port 444, and out of the input/output port 444. In this example, an optical wave propagates in a loop between the optical reflectors of the optical filter 442 and the optical reflector 448. An output coupler 452 couples out a fraction 454 of the optical wave propagating around the loop. Some laser cavities can incorporate one or more of the elements described above together, for instance, a gain element can also be configured to comprise a cavity length control module or optical reflector.

FIG. 4B is a schematic diagram of an example laser cavity 400B comprising an optical filter 462 that is configured as the optical circuit 300B shown in FIG. 3B. The laser cavity 400B is an example implementation of a standing-wave laser cavity using the optical filter 462 as a wavelength filter. In some implementations, a laser cavity can comprise more than one wavelength selective element. The optical filter 462 comprises an input/output port 464 that is configured to receive an optical wave and provide an optical wave. The laser cavity 400B further comprises a gain medium 466 configured to provide an optical gain to an optical wave propagating through the laser cavity 400B. The laser cavity 400B further comprises an optical reflector 468 and a cavity length control module 470, which is configured to control the length of the cavity and optical mode overlap within the cavity. An optical wave propagates in the laser cavity 400B around a loop that traverses through the gain medium 466, into the input/output port 464, and out of the input/output port 464. In this example, an optical wave propagates in a loop between the optical reflectors of the optical filter 462 and the optical reflector 468. An output coupler 472 couples out a fraction 474 of the optical wave propagating around the loop. Some laser cavities can incorporate one or more of the elements described above together, for instance, a gain element can also be configured to comprise a cavity length control module or optical reflector.

As previously described, reflectors within an optical circuit configured as an optical filter can comprise Bragg gratings. In some implementations, including a Bragg grating as a reflector in a laser can allow for selection of modes within a cavity. Some cavities can support multiple optical modes. By tuning the reflectance peak of a Bragg grating, one or more optical modes can be selected to have gain in a cavity, allowing for optical losses associated with multiple modes to be avoided. In some implementations, configuring a Bragg grating can involve designing the Bragg grating to have a reflectance peak that is based on the grating period or refractive index of materials that form the Bragg grating. In some implementations, a Bragg grating can be dynamically tuned post-fabrication during operation of a device. For instance, temperature or external electrical fields can be used to tune Bragg gratings.

FIG. 4C is a schematic diagram of an example laser cavity 400C comprising an optical filter 482 configured as a phased-array wavelength filter, i.e., as shown in FIG. 1B, to control the lasing wavelength. The optical filter 482 comprises an input port 484 that is configured to receive an optical wave and an output port 485 that is configured to provide an optical wave. The laser cavity 400C further comprises a gain medium 486 configured to provide an optical gain to an optical wave propagating through the laser cavity 400C. The laser cavity 400C further comprises an optical isolator 488 that is configured to control a direction of an optical wave in the laser cavity 400C. The laser cavity 400C also comprises a cavity length control module 490 configured to control the length of the cavity and optical mode overlap within the cavity. An optical wave propagates in the laser cavity 400C around a loop that traverses through the gain medium 486, into the input port 484, and out of the output port 485. An output coupler 492 couples out a fraction 494 of the optical wave propagating around the loop.

In some examples, alternative implementations can omit the optical isolator 488. In some implementations, components can be configured to perform one or more of the functions described above. For instance, an optical filter can comprise the output coupler.

While not explicitly depicted, some laser cavities can comprise optical filters having a similar configuration to the optical filter shown in FIG. 3C.

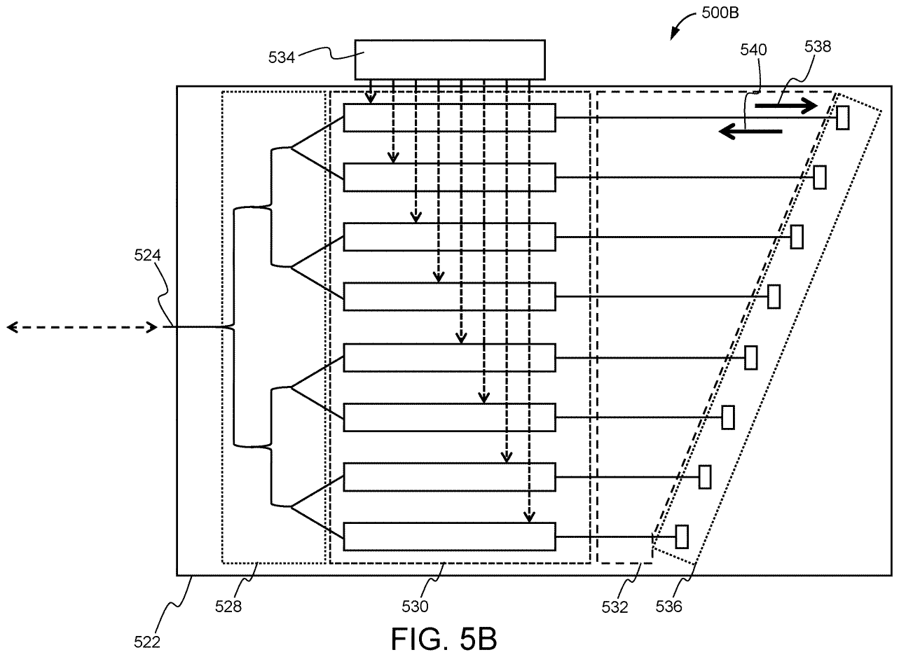

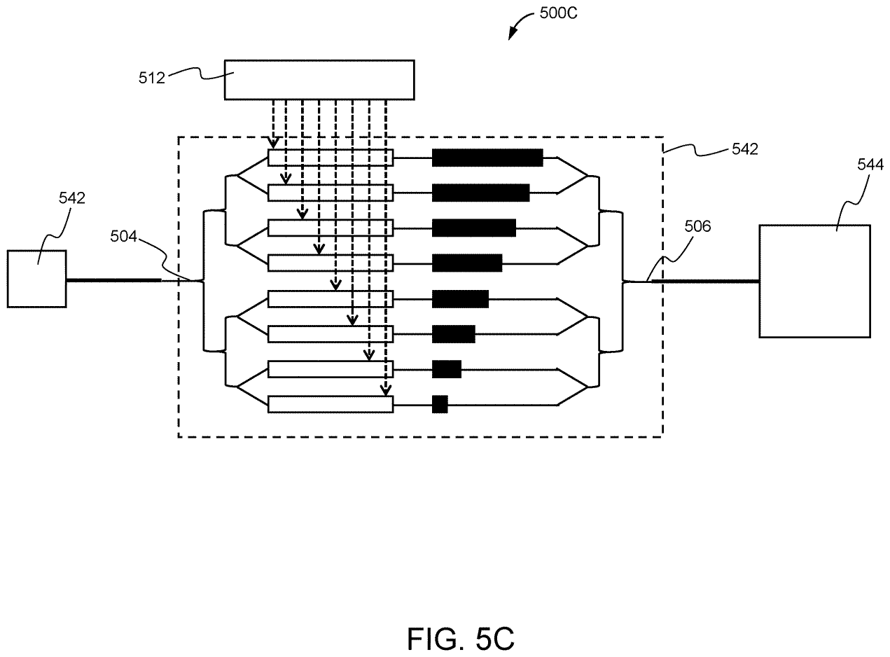

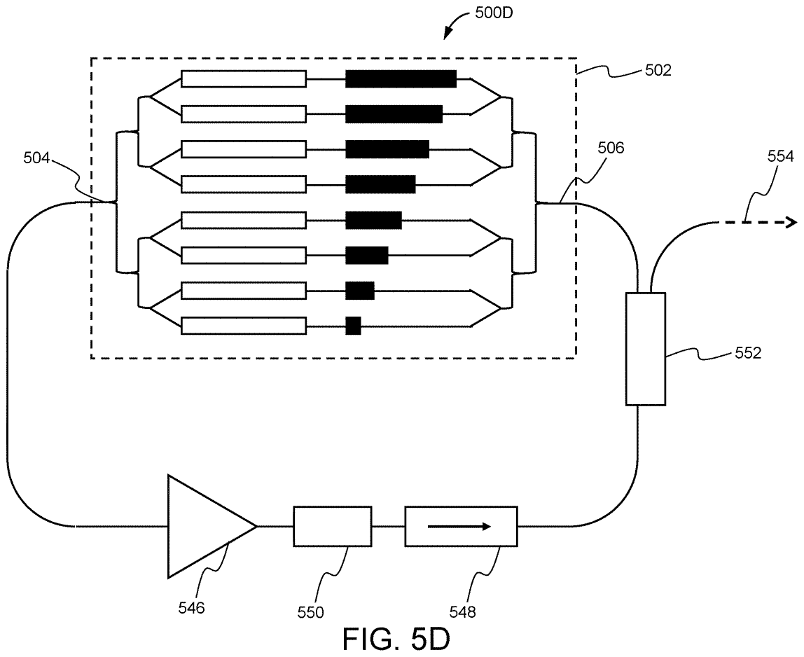

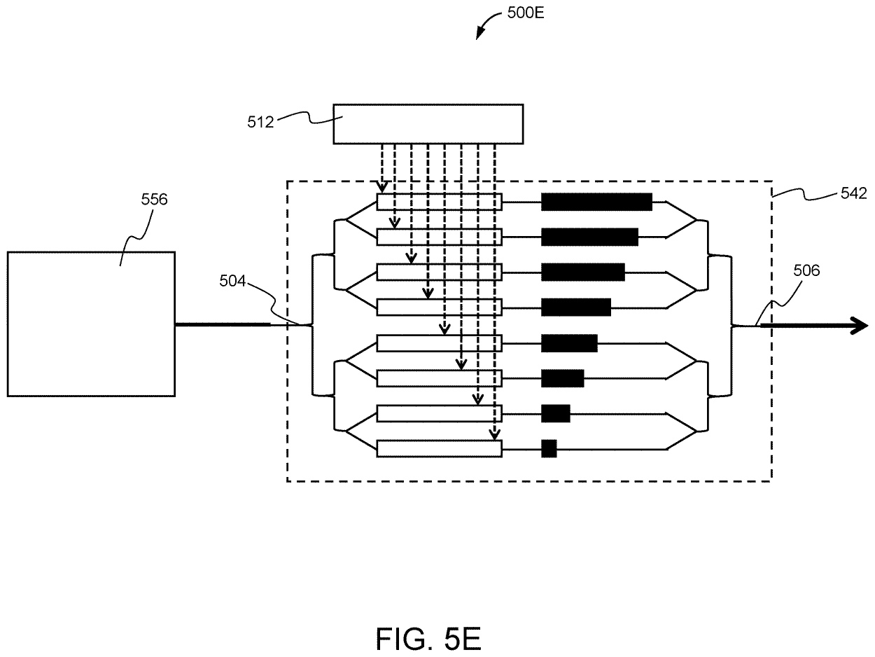

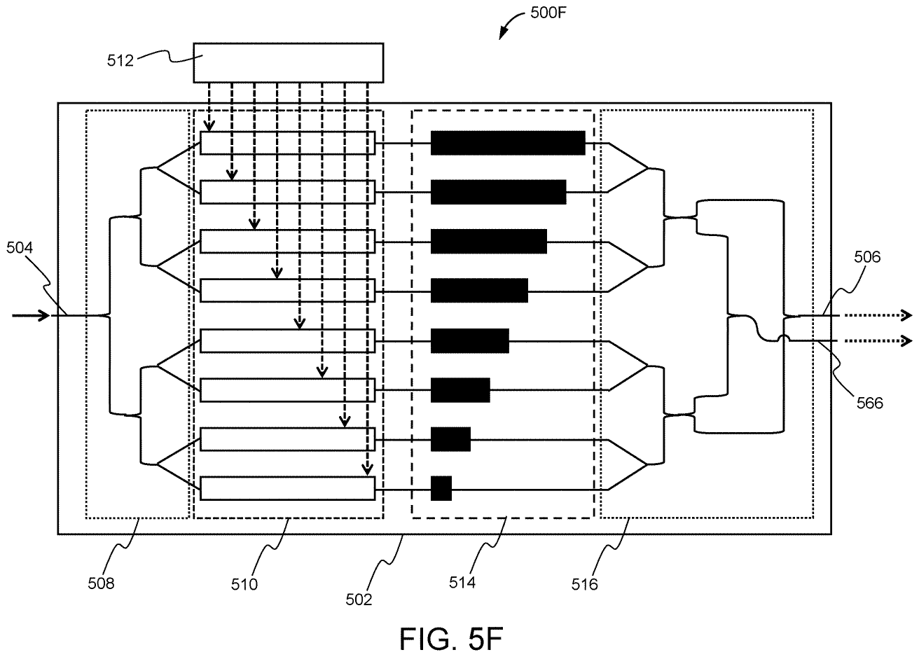

Optical filters can have other configurations. FIG. 5A is a schematic diagram of an example system 500A comprising an optical circuit 502 configured as an optical filter. The optical circuit 502 is configured to receive a first optical wave at an input port 504 and produce a second optical wave at an output port 506. The optical circuit 502 comprises an optical splitting network 508 that is configured to distribute a respective portion of the first optical wave into each 2D-confined path of a plurality of 2D-confined paths, i.e., optical waveguides. In this example, the optical splitting network 508 comprises interconnected power splitters. Each 2D-confined path of the plurality of 2D-confined paths comprises a respective phase shifter such that the optical circuit 502 comprises a plurality of phase shifters 510. Each phase shifter of the plurality of phase shifters 510 is configured to apply a phase shift to an optical wave propagating through a 2D-confined path in response to a phase shift control signal applied by control circuitry 512, which is configured to perform a particular function, as described in more detail below. Each 2D-confined path of the plurality of 2D-confined paths further comprises a respective chromatic dispersion modifying structure such that the optical circuit 502 comprises a plurality of chromatic dispersion modifying structures 514. Each chromatic dispersion modifying structure of the plurality of chromatic dispersion modifying structures 514 is configured to apply a delay to a portion of an optical wave propagating through an optical waveguide. An optical combining network 516 is configured to combine an optical wave from each 2D-confined path of the plurality of 2D-confined paths into the second optical wave.

FIG. 5B is a schematic diagram of an example system 500B comprising an optical circuit 522 configured as an optical filter. The optical circuit 522 is configured to receive an optical wave and produce an optical wave from an input/output port 524. The optical circuit 522 comprises an optical splitting network 528 configured to distribute a respective portion of the optical wave from the input/output port 524 into each 2D-confined path of a set of 2D-confined paths. Each 2D-confined path comprises a respective phase shifter and a respective chromatic dispersion modifying structure such that the optical circuit 522 comprises a set of phase shifters 530 and a set of chromatic dispersion modifying structures 532. In this example, the set of chromatic dispersion modifying structures 532 is formed by portions of 2D-confined paths having different physical lengths. In this example, each phase shifter of the set of phase shifters 530 is configured to receive a phase shift control signal from control circuitry 534, which is configured to perform a particular function, as described in more detail below. The optical circuit 522 further comprises a set of optical reflectors 536 such that an end of each 2D-confined path is in optical communication with a respective optical reflector of the set of optical reflectors 536. Each optical reflector redirects respective optical waves such that the optical splitting network 528 can be used as an optical combining network. By way of example, an arrow 538 is included to show the direction of an optical wave before reflection by the optical reflector and an arrow 540 is included to show the direction of an optical wave after reflection by the optical reflector.

In some implementations, each of the control circuitry 512 and the control circuitry 534 can be configured to apply a sequence of two or more sets of phase shift control signals to the plurality of phase shifters. In some implementations, a first set of phase shift control signals of the two or more sets of phase shift control signals is different from a second set of phase shift control signals of the two or more sets of phase shift control signals. Such implementations can allow for the optical filter to be used in a spectrometer.

By way of example, FIG. 5C is a schematic diagram of an example system 500C. The system 500C comprises the optical circuit 502 and the control circuitry 512. In this example, the input port 504 of the optical circuit 502 is in optical communication with an optical coupler 542. The output port 506 of the optical circuit 502 is in optical communication with a photodetector 544. In some implementations, the system 500C can be configured such that the optical circuit 502 receives an optical wave comprising a plurality of optical frequencies. By applying a sequence of two or more sets of phase shift control signals, the optical circuit 502 can be configured to select and provide portions of the optical wave corresponding to the plurality of optical frequencies to the photodetector 544.

In other words, an optical bandwidth of an optical wave at the input port 504 can be greater than an optical bandwidth of an optical wave at the output port 506. In other words, an optical wave at the output port 506 can have a first peak optical wavelength based at least in part on a first set of phase shift control signals and a second peak optical wavelength based at least in part on a second set of phase shift control signals, where the first peak optical wavelength is different from the second peak optical wavelength.

In some implementations, the system 500C can be arranged in layers of an integrated circuit device such that the system 500C is configured as an on-chip spectrometer. Such implementations can allow for wavelength characterization of optical signals.

The optical splitting network of the optical circuit 502 comprises a plurality of optical power splitters, each having two outputs that are directed to 2D-paths. By increasing a number of 2D-confined paths in the optical splitting network, an optical circuit can be configured to filter optical waves with a finer wavelength resolution. In other words, an output optical wave can have a narrower optical bandwidth by increasing a number of 2D-confined paths. By way of example, an optical circuit can comprise at least 32 2D-confined paths. By way of example, an optical circuit can comprise at least 64 2D-confined paths. By way of example, an optical circuit can comprise at least 128 2D-confined paths.

In some implementations, the optical coupler 542 can be configured as a grating coupler that can couple between free-space optical waves and waveguided optical waves. In some implementations, the optical coupler 542 can be configured as an edge coupler at an edge of an integrated circuit device. In some implementations, the optical coupler 542 can be in optical communication with other components, such as an optical source.

Providing a sequence of phase shift control signals can also allow an optical filter to be used to perform Q-switching or modulation of a laser. By way of example, FIG. 5D is a schematic diagram of an example system 500D configured as a laser cavity. The system 500D comprises the optical circuit 502 and the control circuitry 512. The system 500D further comprises a gain medium 546 configured to provide an optical gain to an optical wave propagating through the system 500D. The system 500D further comprises an optical isolator 548 that is configured to control a direction of an optical wave in the system 500D. The system 500D also comprises a cavity length control module 550 configured to control the length of the cavity and optical mode overlap within the cavity. An optical wave propagates in the system 500D around a loop that traverses through the gain medium 546, into the input port 504, and out of the output port 506. An output coupler 552 couples out a fraction 554 of the optical wave propagating around the loop. By applying a sequence of two or more sets of phase shift control signals using the control circuitry 512, the optical circuit 502 can be configured to control a quality factor of an optical cavity by introducing losses to the optical cavity. This phenomenon can be referred to as Q-switching.

In other words, an optical wave at an output port of the optical circuit 502 can have a first optical intensity based at least in part on the first set of phase shift control signals and a second optical intensity based at least in part on the second set of phase shift control signals, where the first optical intensity is different from the second optical intensity.

In some implementations, the first set of phase shift control signals can correspond to a “lossy” setting such that an optical wave produced by the optical cavity is low in intensity. In some examples, a set of phase shift control signals corresponding to this lossy setting can be determined and stored in circuitry such as memory such that a system can switch back and forth between a lossy setting and a non-lossy setting, where an optical wave produced by the optical cavity is higher in intensity. Such implementations can allow for the production of optical pulses.

FIG. 5E is a schematic diagram of an example system 500E. The system 500E comprises the optical circuit 502. The input port 504 of the optical circuit 502 is in optical communication with a laser cavity 556 comprising a gain medium (not shown). Similar to the implementation described for FIG. 5D, phase shift control signals can be configured to modulate the output of the laser cavity 556.

In other words, as shown in FIGS. 5D-5E, at least one of the input port or the output port can be in optical communication with a gain medium configured to provide an optical gain to an optical wave propagating through the gain medium.

FIG. 5F is a schematic diagram of an example system 500F. The system 500F comprises a similar configuration to the system 500A. In this example, the system 500F is configured as an optical switch. In this example, the system 500F further comprises a second output port 566. The system 500F can be configured to direct an optical wave to either of the output port 506 or the second output port 566, i.e., portions of optical waveguides.

Without intending to be bound by theory, the following is an example of a theoretical model for illustrating features.

In some examples, an optical wave can be described in terms of an energy of the optical wave per unit time, or optical power. In some examples, an optical wave can be described in terms of an optical power per unit area, or optical intensity. The optical power and optical intensity can be used to quantify an energy associated with an optical wave.

In some examples, the output power of an optical filter can be expressed as

$${P}_{thru .} = {P}_{i n} \frac{{sin}^{2} \{ N Λ ( v ) \}}{{sin}^{2} \{ Λ ( v ) \}}$$

where Pₜₕᵣᵤ is the filtered power, Pᵢₙ is the input power, N is the number of differential delay channels, and Λ(v) is the differential frequency-dependent delay. The differential frequency dependent delay can be related to the frequency ν, free-space differential length Δz, refractive index n(v₀) and speed of light c:

$$Λ ( v ) = \frac{2 π v}{c} \times n ( v ) \times Δ z .$$

In some examples, the free spectral range of the filter Δv_{FSR} can be related to the differential delay phase Λ(v₉) at the center frequency v₀, the refractive index n(v₀) and the group index n_{g}(v₀) at the center frequency to yield:

$$Δ {v}_{FSR} \approx \frac{π {v}_{0}}{Λ ( {v}_{0} )} \frac{n ( {v}_{0} )}{{n}_{g} ( {v}_{0} )} .$$

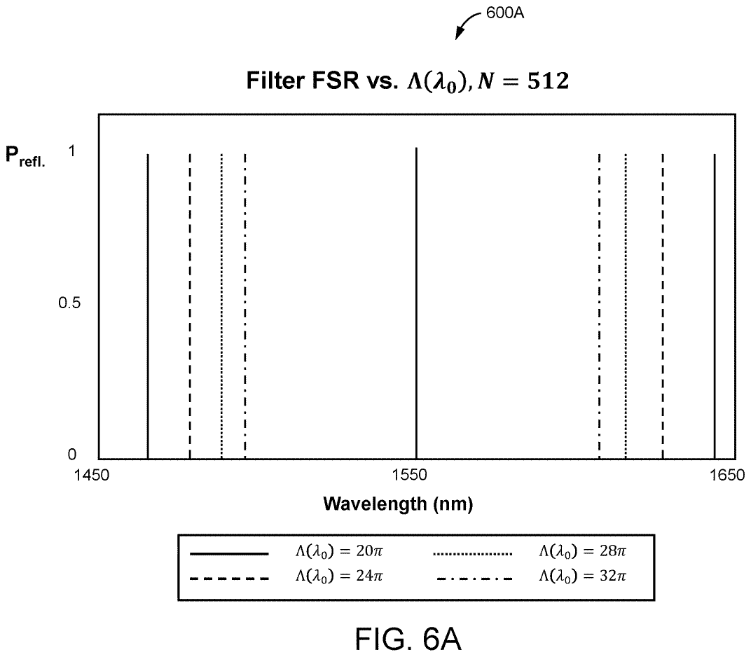

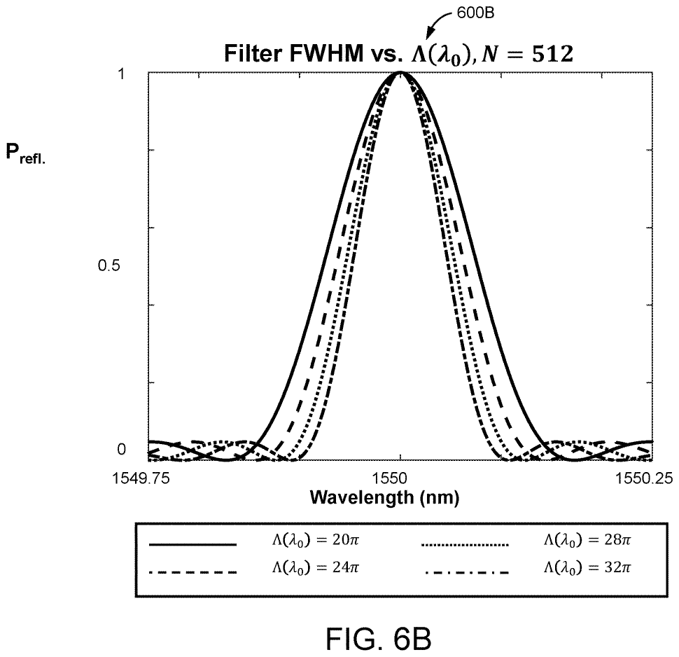

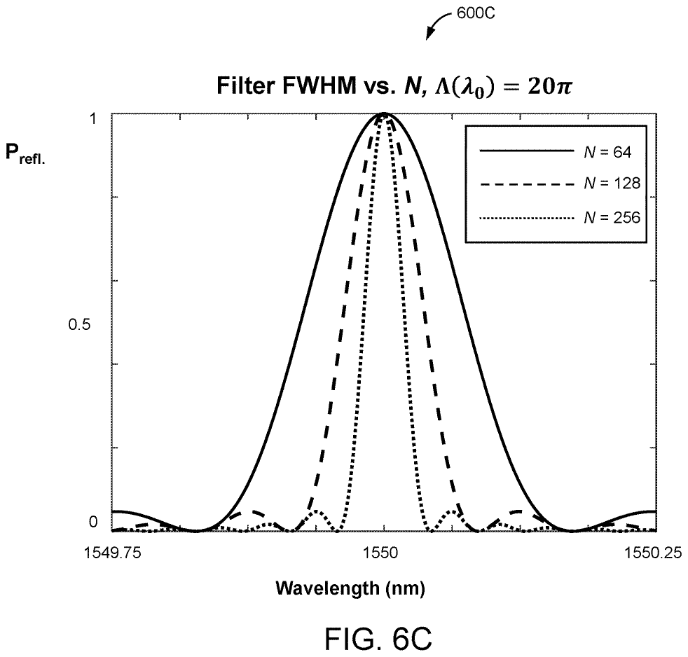

FIGS. 6A-6C depict plots of numerical simulations associated with designing optical filters. Specifically, FIGS. 6A-6C depict plots of numerical simulations for optical filters designed to operate at a center wavelength of 1550 nm. FIG. 6A depicts a plot 600A of numerical simulations associated with the effect of the differential delay, here shown as accrued phase, on the filter FSR. Here, the wavelength axis spans 1450 nm and 1650 nm, including 1550 nm. As shown by the plot 600A, increasing the differential delay can decrease the FSR.

FIG. 6B depicts a plot 600B of numerical simulations associated with the effect of the differential delay on the FWHM of the transmission spectrum. Here, the wavelength axis spans 1549.75 nm and 1550.25 nm, including 1550 nm. As shown by the plot 600B, increasing the differential delay can decrease the transmission spectrum.

FIG. 6C depicts a plot 600C of numerical simulations associated with the effect of the number of delay channels on filter FWHM. Here, the wavelength axis spans 1549.75 nm and 1550.25 nm, including 1550 nm. As shown by the plot 600C, increasing the number of delay channels can decrease the filter FWHM. By way of example, the plot 600C shows traces associated with 64 delay channels, 128 delay channels, and 256 delay channels.

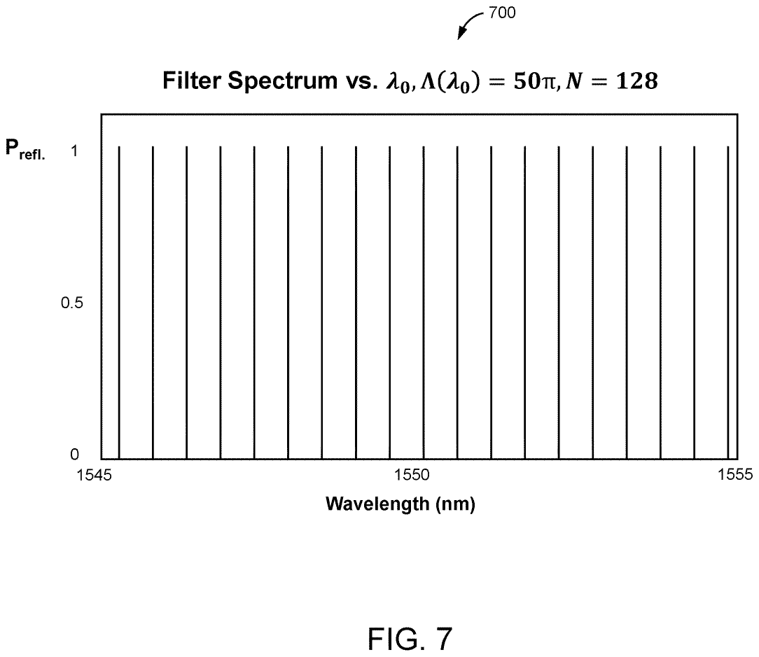

In some implementations, a laser cavity, such as the laser cavities shown in FIGS. 4A-4C or the laser cavity shown in FIG. 5D, can be configured to produce an output wave that is associated with a wavelength spectrum having a plurality of intensity peaks. In such implementations, a gain medium of the laser cavity can be configured to lase at multiple wavelengths such that the laser cavity produces multiple wavelengths, i.e., a wavelength spectrum having a plurality of intensity peaks. In other words, a gain medium can be configured to provide a respective optical gain to each wavelength of a plurality of wavelengths. FIG. 7 depicts a plot 700 of numerical simulations associated with an optical filter. In this example, the differential delay is configured to produce a plurality of intensity peaks that are semi-regularly spaced along the wavelength axis. Here, the wavelength axis spans 1545 nm and 1555 nm, including 1550 nm. In some examples, this spacing can also be referred to as “periodic” spacing. In other words, each spacing between adjacent intensity peaks of the plurality of intensity peaks is substantially equal. Some laser cavities configured to produce a plurality of semi-regularly spaced intensity peaks can be referred to as optical combs. In some implementations, applying chromatic dispersion to an optical wave using portions of a 2D-confined path, such as shown in FIG. 4B, can allow for control over the optical interference and production of the plurality of intensity peaks produced by a laser cavity.

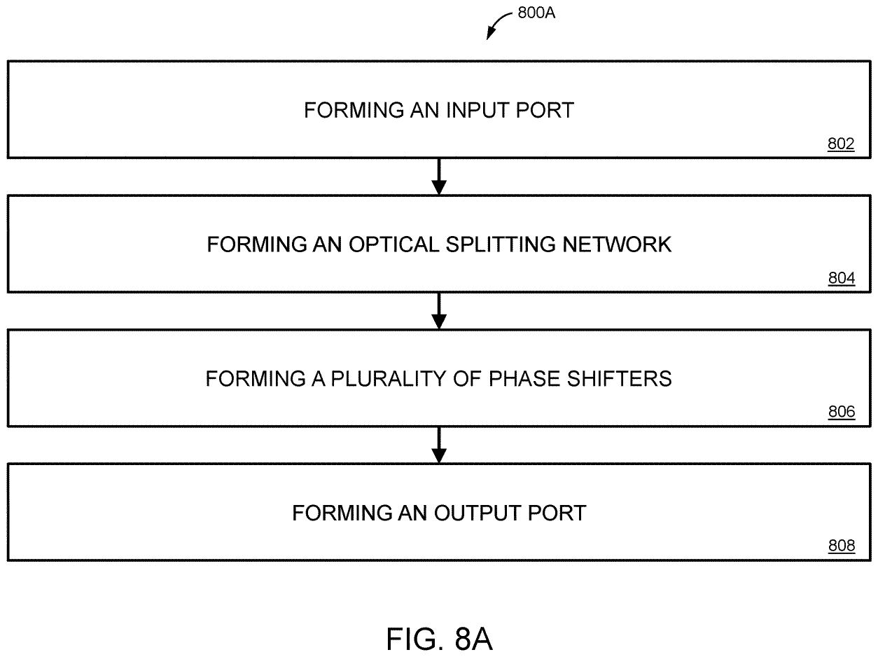

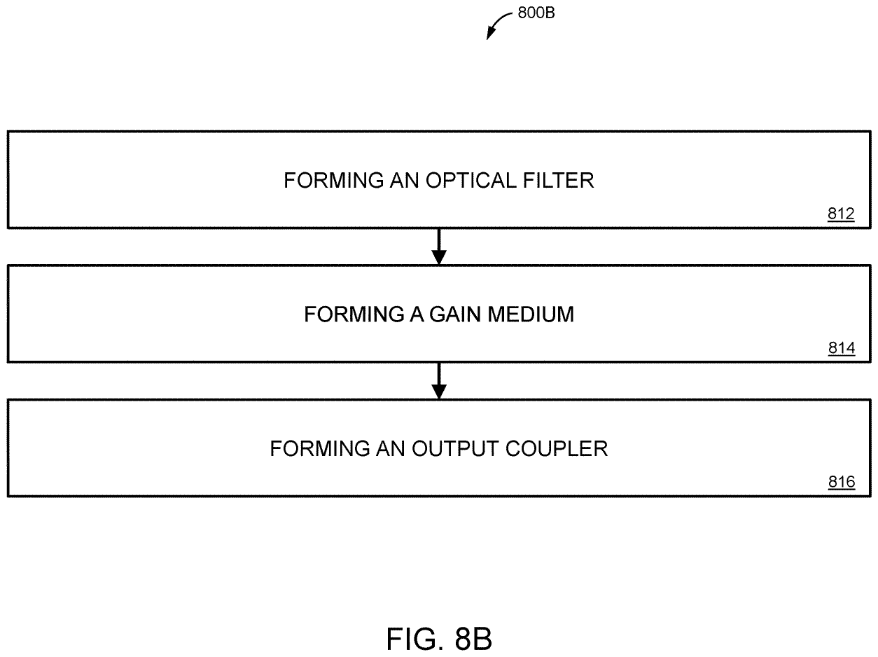

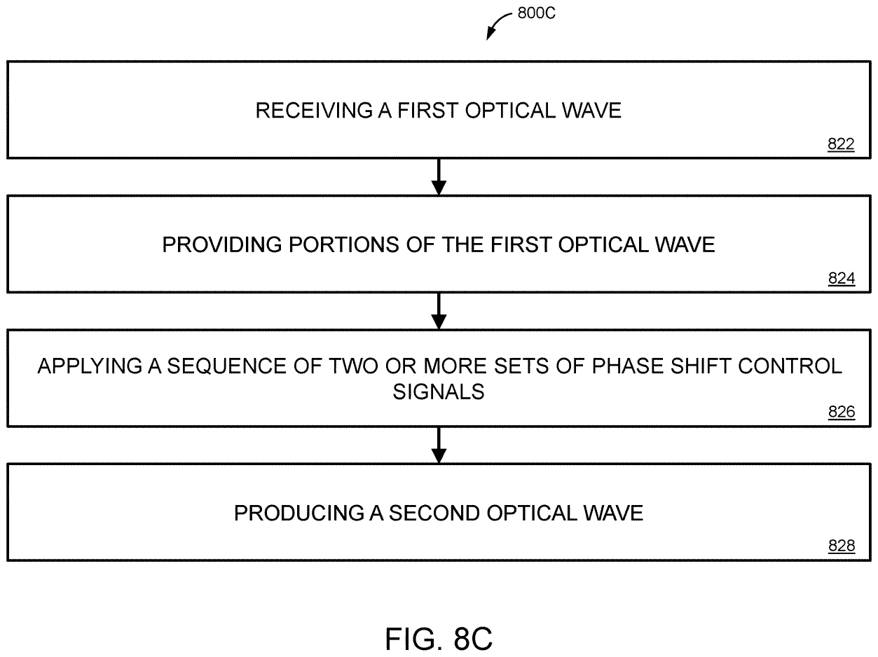

FIG. 8A is a flowchart of an example method 800A. The example method 800A can be used to form an apparatus, for example, any of the apparatuses shown in FIGS. 1A-1D or FIGS. 3A-3C. The method 800A comprises forming 802 an input port. In some implementations, the input port can be configured to receive an optical wave. The method 800A further comprises forming 804 an optical splitting network. In some implementations, the optical splitting network can be configured to provide a respective portion of the first optical wave from the input port to each phase shifter of a plurality of phase shifters. In some implementations, the optical splitting network can comprise a plurality of optical power splitters, where each optical power splitter of the plurality of optical power splitters is configured to provide respective portions of an input optical wave to each of two or more respective outputs according to a respective optical power splitting ratio associated with each optical power splitter. The method 800A further comprises forming 806 a plurality of phase shifters. In some implementations, each phase shifter can be configured to apply a phase shift to an optical wave propagating through that phase shifter in response to a phase shift control signal. The method 800A further comprises forming 808 an output port. In some implementations, the output port can be in optical communication with the plurality of phase shifters such that the output port is configured to provide a second optical wave comprising a respective optical wave from each phase shifter of the plurality of phase shifters. In some implementations, a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path. In some implementations, a first optical path length along a portion of a 2D-confined path between a first optical power splitter and a phase shifter of the plurality of phase shifters is at least two times a second optical path length along a portion of a 2D-confined path between the first optical power splitter and a different phase shifter of the plurality of phase shifters.

FIG. 8B is a flowchart of an example method 800B. The method 800B can be used to form an apparatus, for example, any of the apparatuses shown FIGS. 4A-4C or FIG. 5D. The method 800B comprises forming 812 an optical filter. In some implementations, the optical filter can be configured to receive a first optical wave at an optical filter input and produce, based at least in part on different amounts of phase delay provided by each of three or more 2D-confined paths receiving different respective portions of the first optical wave, a second optical wave at an optical filter output. In some implementations, the optical filter can comprise a plurality of optical power splitters, where each optical power splitter of the plurality of optical power splitters provides a respective portion of the first optical wave to a 2D-confined path of the three or more 2D-confined paths. In some implementations, the optical filter can further comprise a plurality of phase shifters, wherein each phase shifter is configured to apply a phase shift to an optical wave propagating through that phase shifter in response to a phase shift control signal. The method 800B further comprises forming 814 a gain medium. In some implementations, the gain medium can be configured to provide an optical gain to an optical wave propagating around a loop that traverses through the gain medium and into the optical filter input and out of the optical filter output. The method 800B further comprises forming 816 an optical coupler. In some implementations, the output coupler can be configured to couple out a fraction of the optical wave propagating around the loop.

FIG. 8C is a flowchart of an example method 800C. The method 800C can be used to operate an apparatus, for example, any of the apparatuses shown in FIGS. 1A-1D, FIGS. 3A-3C, FIGS. 4A-4C, or FIGS. 5A-5E. The method 800C comprises receiving 822 a first optical wave. In some implementations, an input port can receive the first optical wave. The method 800C further comprises providing 824 portions of the first optical wave. In some implementations, a respective portion of the first optical wave can be provided from the input port to each phase shifter of a plurality of phase shifters using an optical splitting network. In some implementations, an optical splitting network can comprise a plurality of optical power splitters, where each optical power splitter of the plurality of optical power splitters is configured to provide respective portions of an input optical wave to each of two or more respective outputs according to a respective optical power splitting ratio associated with each optical power splitter. The method 800C further comprises applying 826 a sequence of two or more sets of phase shift control signals. In some implementations, the sequence can be applied to the plurality of phase shifters using control circuitry. The method 800C further comprises producing 828 a second optical wave. In some implementations, the second optical wave can be produced at an output port in optical communication with the plurality of phase shifters and can comprise a respective optical wave from each phase shifter of the plurality of phase shifters. In some implementations, a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path. In some implementations, a first set of phase shift control signals of the two or more sets of phase shift control signals is different from a second set of phase shift control signals of the two or more sets of phase shift control signals.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an input port configured to receive a first optical wave;
an optical splitting network configured to provide a respective portion of the first optical wave from the input port to each phase shifter of a plurality of phase shifters, the optical splitting network comprising
a plurality of optical power splitters, where each optical power splitter of the plurality of optical power splitters is configured to provide respective portions of an input optical wave to each of two or more respective outputs according to a respective optical power splitting ratio associated with each optical power splitter;
the plurality of phase shifters, wherein each phase shifter is configured to apply a phase shift to an optical wave propagating through that phase shifter in response to a phase shift control signal; and
an output port in optical communication with the plurality of phase shifters such that the output port is configured to provide a second optical wave comprising a respective optical wave from each phase shifter of the plurality of phase shifters;
wherein the apparatus is configured such that a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path; and
wherein a first optical path length along a portion of a 2D-confined path between a first optical power splitter and a phase shifter of the plurality of phase shifters is at least two times a second optical path length along a portion of a 2D-confined path between the first optical power splitter and a different phase shifter of the plurality of phase shifters.

2. The apparatus of claim 1, wherein each 2D-confined path of the set of 2D-confined paths is configured to confine a respective optical wave in two dimensions and provide a different amount of phase delay than each other 2D-confined path in the set of 2D-confined paths.

3. The apparatus of claim 1, wherein each 2D-confined path of the set of 2D-confined paths comprises a respective portion of the optical splitting network.

4. The apparatus of claim 1, wherein each 2D-confined path of the set of 2D-confined paths has a different physical length such that the different physical lengths provide at least some of the different amounts of phase delay.

5. The apparatus of claim 1, wherein each 2D-confined path of the set of 2D-confined paths comprises a chromatic dispersion modifying structure configured to provide an amount of chromatic dispersion to an optical wave propagating through the chromatic dispersion modifying structure.

6. The apparatus of claim 5, wherein each chromatic dispersion modifying structure is formed from a respective portion of a 2D-confined path of the set of 2D-confined paths, where each respective portion has at least one of a refractive index or width that is different from that of adjacent portions of the 2D-confined path, and the respective portion has a length along a propagation axis of the 2D-confined path that is different from lengths of the respective portions of each other 2D-confined path in the set of 2D-confined paths.

7. The apparatus of claim 1, wherein the set of 2D-confined paths comprises at least ten 2D-confined paths.

8. The apparatus of claim 7, wherein the set of 2D-confined paths consists of no more than 10,000 2D-confined paths.

9. The apparatus of claim 1, further comprising an optical combining network configured to combine a respective optical wave from each phase shifter of the plurality of phase shifters into the second optical wave.

10. The apparatus of claim 9, wherein each phase shifter of the plurality of phase shifters is in optical communication with a respective optical reflector that redirects respective optical waves to use the optical splitting network as the optical combining network.

11. The apparatus of claim 10, wherein each optical reflector comprises a Bragg grating, an optical coating comprising one or more layers of material, or an interface between a first material and a second material.

12. The apparatus of claim 9, further comprising a second optical waveguiding structure configured to provide an optical wave from the optical combining network to the output port.

13. The apparatus of claim 12, wherein the optical combining network comprises a plurality of optical power splitters, where each optical power splitter of the plurality of optical power splitters is configured to provide respective portions of an input optical wave to each of two or more respective outputs according to a respective optical power splitting ratio associated with each optical power splitter, and where the plurality of optical power splitters is arranged in a sequence along the second optical waveguiding structure.

14. The apparatus of claim 1, wherein at least one of (1) a peak optical wavelength of the first optical wave is different from a peak optical wavelength of the second optical wave or (2) an optical bandwidth of the first optical wave is different from an optical bandwidth of the second optical wave.

15. The apparatus of claim 1, wherein the optical splitting network comprises an optical waveguiding structure and at least some optical power splitters of the plurality of optical power splitters are arranged in a sequence along the optical waveguiding structure.

16. The apparatus of claim 15, wherein each optical power splitter of the plurality of optical power splitters is arranged in a sequence along the optical waveguiding structure.

17. The apparatus of claim 16, wherein the first optical power splitter is first in the sequence.

18. An apparatus comprising:
an optical filter configured to receive a first optical wave at an optical filter input and produce, based at least in part on different amounts of phase delay provided by each of three or more two-dimensionally (2D) confined paths receiving different respective portions of the first optical wave, a second optical wave at an optical filter output, the optical filter comprising
a plurality of optical power splitters, where each optical power splitter of the plurality of optical power splitters provides a respective portion of the first optical wave to a 2D-confined path of the three or more 2D-confined paths, and
a plurality of phase shifters, wherein each phase shifter is configured to apply a phase shift to an optical wave propagating through that phase shifter in response to a phase shift control signal;
a gain medium configured to provide an optical gain to an optical wave propagating around a loop that traverses through the gain medium and into the optical filter input and out of the optical filter output; and
an output coupler that couples out a fraction of the optical wave propagating around the loop;
wherein a first optical path length along a portion of a 2D-confined path between a first optical power splitter and a phase shifter of the plurality of phase shifters is at least two times a second optical path length along a portion of a 2D-confined path between the first optical power splitter and a different phase shifter of the plurality of phase shifters.

19. The apparatus of claim 18, wherein at least one of (1) a peak optical wavelength of the first optical wave is different from a peak optical wavelength of the second optical wave or (2) an optical bandwidth of the first optical wave is different from an optical bandwidth of the second optical wave.

20. The apparatus of claim 18, wherein each 2D-confined path of the three or more 2D-confined paths has a different physical length such that the different physical lengths provide at least some of the different amounts of phase delay.

21. The apparatus of claim 18, wherein the second optical wave is associated with a wavelength spectrum comprising a plurality of intensity peaks.

22. The apparatus of claim 21, wherein each spacing between adjacent intensity peaks of the plurality of intensity peaks is substantially equal.

23. The apparatus of claim 18, wherein the gain medium is configured to provide a respective optical gain to each wavelength of a plurality of wavelengths.

24. An apparatus comprising:
an input port configured to receive a first optical wave;
an optical splitting network configured to provide a respective portion of the first optical wave from the input port to each phase shifter of a plurality of phase shifters, the optical splitting network comprising
a plurality of optical power splitters, where each optical power splitter of the plurality of optical power splitters is configured to provide respective portions of an input optical wave to each of two or more respective outputs according to a respective optical power splitting ratio associated with each optical power splitter;
the plurality of phase shifters, wherein each phase shifter is configured to apply a phase shift to an optical wave propagating through that phase shifter in response to a phase shift control signal;
an output port in optical communication with the plurality of phase shifters such that the output port is configured to provide a second optical wave comprising a respective optical wave from each phase shifter of the plurality of phase shifters; and
control circuitry configured to apply a sequence of two or more sets of phase shift control signals to the plurality of phase shifters;
wherein the apparatus is configured such that a respective portion of the first optical wave propagating from the input port to the output port propagates along each two-dimensionally (2D) confined path of a set of 2D-confined paths, where each 2D-confined path is configured to provide an amount of phase delay to an optical wave propagating in that 2D-confined path; and
wherein a first set of phase shift control signals of the two or more sets of phase shift control signals is different from a second set of phase shift control signals of the two or more sets of phase shift control signals.

25. The apparatus of claim 24, wherein the second optical wave has a first peak optical wavelength based at least in part on the first set of phase shift control signals and a second peak optical wavelength based at least in part on the second set of phase shift control signals, where the first peak optical wavelength is different from the second peak optical wavelength.

26. The apparatus of claim 24, further comprising a photodetector in optical communication with the output port.

27. The apparatus of claim 24, further comprising an optical coupler in optical communication with the input port.

28. The apparatus of claim 24, wherein an optical bandwidth of the first optical wave is greater than an optical bandwidth of the second optical wave.

29. The apparatus of claim 24, wherein the second optical wave has a first optical intensity based at least in part on the first set of phase shift control signals and a second optical intensity based at least in part on the second set of phase shift control signals, where the first optical intensity is different from the second optical intensity.

30. The apparatus of claim 24, wherein at least one of the input port or the output port is in optical communication with a gain medium configured to provide an optical gain to an optical wave propagating through the gain medium.

31. The apparatus of claim 30, wherein the gain medium is configured to provide an optical gain to an optical wave propagating around a loop that traverses through the gain medium and into the input port and out of the output port.

32. The apparatus of claim 24, wherein the set of 2D-confined paths comprises at least 64 2D-confined paths.

33. The apparatus of claim 24, wherein the input port, the optical splitting network, the plurality of phase shifters, and the output port are distributed across one or more layers of a first integrated circuit device, and the control circuitry is distributed across one or more layers of a second integrated circuit device in electrical communication with the first integrated circuit device.
